(19) United States
(12) Patent Application Publication
(10) Pub. No.: US 2021/0067490 A1
(43) Pub. Date: Mar. 4, 2021

(54) NETWORK MANAGEMENT DEVICE, METHOD FOR MANAGING NETWORK, AND NETWORK SYSTEM

(71) Applicant: FUJITSU LIMITED, Kawasaki-shi (JP)

(72) Inventor: Takamichi NISHIJIMA, Kawasaki (JP)

(73) Assignee: FUJITSU LIMITED, Kawasaki-shi (JP)

(21) Appl. No.: 16/984,719

(22) Filed: Aug. 4, 2020

(30) Foreign Application Priority Data
Aug. 30, 2019 (JP) 2019-158887

(51) Int. Cl. H04L 29/06; H04L 12/26; H04L 12/851; H04L 12/741

(52) U.S. Cl. CPC H04L 63/0236; H04L 43/08; H04L 47/24; H04L 63/1458; H04L 63/1425; H04L 63/1416; H04L 45/745

(57) ABSTRACT

A network management includes a memory and a processor coupled to the memory. The processor configured to calculate respective communication routes of traffic to be forwarded from each of the plurality of edge routers to an attack target device that receives an attack from an outside of the network, set a communication route of traffic to a second router such that the communication routes merge at a first router, and instruct the first router to suppress forwarding of traffic of the attack. The processor selects the first router and the second router so as to satisfy a condition regarding a load of forward processing of traffic in the network and not to allow the traffic to loop from among the plurality of edge routers and the plurality of intermediate routers on the basis of a connection relationship between the plurality of edge routers and the plurality of intermediate routers.

### CROSS-REFERENCE TO RELATED APPLICATION

This application is based upon and claims the benefit of priority of the prior Japanese Patent Application No. 2019-158887, filed on Aug. 30, 2019, the entire contents of which are incorporated herein by reference.

### FIELD

The embodiments discussed herein are related to a network management device, a method for managing a network, and a network system.

### BACKGROUND

For example, there are denial of service (DoS) attacks and distributed denial of service (DDoS) attacks as attacks targeting servers in a network (see patent Documents that Japanese Laid-open Patent Publication No. 2017-50832 and No. 2004-248185, for example). In this type of attack, there is a possibility that a large number of internet protocol (IP) packets are transmitted to a server to be attacked (hereinafter referred to as “attack target server”), thereby causing the attack target server to consume resources and disturbing and stopping provision of a service of the attack target server.

A unit for protecting the attack target server from such attacks includes a detection device that detects traffic (hereinafter referred to as “attack traffic”) including IP packets for malicious attacks, and a defense device such as a firewall that restricts forwarding of the attack traffic to the attack target server.

The detection device is connected between the attack target server and the defense device, monitors traffic, analyzes a communication amount, behavior, and the like of the traffic, thereby determining whether the traffic is the attack traffic. Thereby, the detection device detects the attack traffic and notifies a network management server of information of an address and a port indicating a destination and a transmission source of the attack traffic, and a protocol type of the attack traffic, in addition to a detection notification of the attack traffic.

The management server sets blocking of the attack traffic to the defense device according to the information notified from the detection device. Thereby, an inflow of the attack traffic to the attack target server is suppressed, and a load on the attack target server is reduced.

For example, Japanese Laid-open Patent Publication No. 2017-50832, Japanese Laid-open Patent Publication No. 2004-248185, and the like are disclosed as related art.

### SUMMARY

According to an aspect of the embodiments, a network management device for managing a network including a plurality of edge routers and a plurality of intermediate routers connected between the plurality of edge routers, the network management device includes a memory and a processor coupled to the memory and configured to, calculate respective communication routes of traffic to be forwarded from each of the plurality of edge routers to an attack target device that receives an attack from an outside of the network, set a communication route of traffic to a second router such that the communication routes merge at a first router, and instruct the first router to suppress forwarding of traffic of the attack, wherein, the processor selects the first router and the second router so as to satisfy a condition regarding a load of forward processing of traffic in the network and not to allow the traffic to loop from among the plurality of edge routers and the plurality of intermediate routers on the basis of a connection relationship between the plurality of edge routers and the plurality of intermediate routers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating a network system of a first comparative example;

FIG. 2 is a configuration diagram illustrating a network system of a second comparative example;

FIG. 3 is a diagram illustrating an example of an operation of collecting route information by a network management server according to an embodiment;

FIG. 4 is a diagram illustrating an operation example of performing defense setting and route setting by the network management server according to the embodiment;

FIG. 5 is a configuration diagram illustrating an example of the network management server;

FIG. 6 is a diagram illustrating an operation of acquiring route information in a first setting example;

FIG. 7 is a diagram illustrating lists of selection conditions and priority conditions and an example of a condition database;

FIG. 8 is a diagram (No. 1) illustrating a method of selecting a defense router and a merging router in the first setting example;

FIG. 9 is a diagram (No. 1) illustrating a route database and a setting database at the time of route setting in the first setting example;

FIG. 10 is a diagram (No. 2) illustrating a method of selecting a defense router and a merging router in the first setting example;

FIG. 11 is a diagram (No. 2) illustrating a route database and a setting database at the time of route setting in the first setting example;

FIG. 12 is a flowchart illustrating an example of the operation of the network management server;

FIG. 13 is a flowchart of processing of selecting a defense router and a merging router in the first setting example;

FIG. 14 is a diagram illustrating an operation of acquiring route information in a second setting example;

FIG. 15 is a diagram illustrating a route database, an adjacency database, a condition database, and a network information database in the second setting example;

FIG. 16 is a diagram illustrating a method of selecting a combination of a defense router and a merging router in the second setting example;

FIG. 17 is a diagram illustrating a route database and a setting database at the time of route setting in the second setting example;

FIG. 18 is a flowchart of processing of selecting a defense router and a merging router in the second setting example;

FIG. 19 is a diagram illustrating a condition database and a network information database in a third setting example;

FIG. 20 is a diagram illustrating a method of selecting a combination of a defense router and a merging router in the third setting example;

FIG. 21 is a diagram illustrating a route database and a setting database at the time of route setting in the third setting example;

FIG. 22 is a flowchart of processing of selecting a defense router and a merging router in the third setting example;

FIG. 23 is a diagram illustrating a setting method in a fourth setting example; and

FIG. 24 is a flowchart of processing of selecting a defense router and a merging router in the fourth setting example.

### DESCRIPTION OF EMBODIMENTS

In the related art, the attack traffic is not suppressed in a communication route from a transmission source device of the attack traffic (hereinafter referred to as “attack source device”) to the defense device. Therefore, a band of other normal traffic is compressed by the attack traffic and normal communication may be disturbed.

To avoid it, if an inflow source edge router of the attack traffic, among edge routers arranged at a boundary of a network that is not managed by the management server, suppresses the attack traffic, compression of the band of other traffic can be prevented.

Here, the edge router can discard the attack traffic by setting and registering address information of the attack traffic in an access control list (ACL), for example.

However, since routers such as edge routers determine a route to a forward destination of an IP packet by searching a routing table on the basis of a destination address of the IP packet, the inflow source edge router of the attack traffic (hereinafter referred to as “inflow source router”) is not able to be specified from the information such as the transmission source address of the attack traffic.

Therefore, for example, if the management server performs the above settings for all the edge routers in the network, the management server does not need to specify the inflow source router and can suppress the attack traffic without compressing the band of other traffic. However, according to this method, the setting for suppressing the attack traffic is performed for all the edge routers. Therefore, there is a possibility of an increase in a load of forward processing of other traffic in each edge router, for example.

Therefore, an object of the present embodiments is to provide a network management device and a method for managing a network capable of suppressing an increase in a load of forward processing of another traffic by suppression of forward of attack traffic.

### First Comparative Example

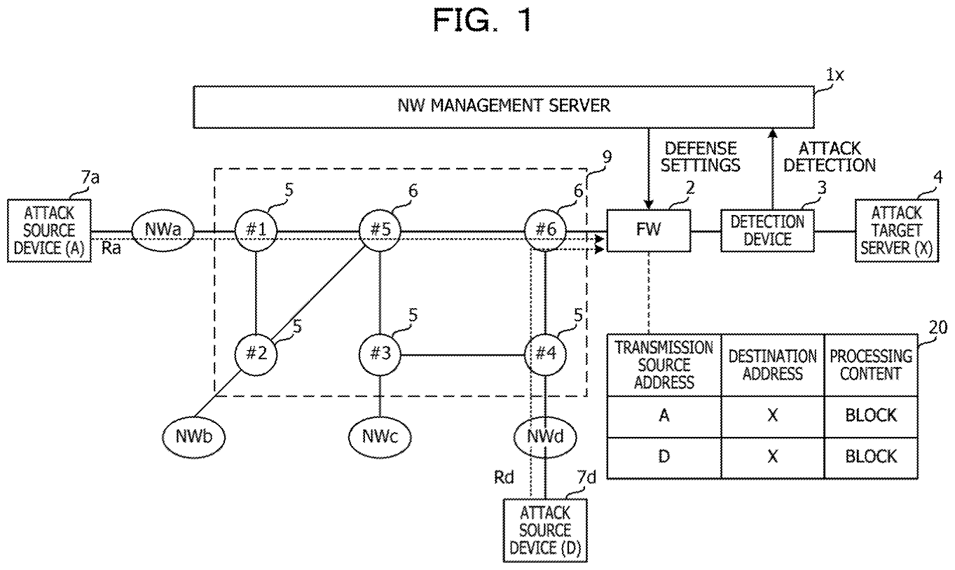

FIG. 1 is a configuration diagram illustrating a network system of a first comparative example. The network system includes a network (NW) management server 1x such as a network element (NE)-operation system (OpS), a firewall 2, a detection device 3, an attack target server 4, and a network 9.

The NW management server 1x is a server such as an NE-OpS, for example, and manages the network 9. The network 9 includes a plurality of edge routers 5 each arranged at boundaries between the network 9 and external networks NWa to NWd, and a plurality of intermediate routers 6 connected between the edge routers 5. The NW management server 1x communicates with each edge router 5 and each intermediate router 6 via another management network (not illustrated).

For example, router IDs “#1” to “#4” are given as identifiers to the respective edge routers 5. Furthermore, for example, router IDs “#5” and “#6” are respectively given as identifiers to the intermediate routers 6. In the following description, for example, the edge router 5 with the identifier “#1” is referred to as “edge router (#1)”, and the intermediate router 6 with the identifier “#5” is referred to as “intermediate router (#5)”. Note that an example of each intermediate router 6 includes, but is not limited to, a core router.

The intermediate router (#6) 6 is adjacent to the intermediate router (#5) 6 and the edge router (#4) 5, and the intermediate router (#5) 6 is adjacent to the edge router (#1) 5, the edge router (#2) 5, and the edge router (#3) 5. Furthermore, the edge routers (#1) 5 to (#4) 5 are connected to the external networks NWa to NWd, respectively. Here, attack source devices 7a and 7d such as servers that attack the attack target server 4 are connected to the external networks NWa and NWd, as an example. Note that the attack target server 4 is an example of an attack target device that receives an attack.

The firewall 2 is connected between the intermediate router (#6) 6 in the network 9 and the detection device 3. The firewall 2 restricts forward of attack traffic from the attack source device 7a or 7d to the attack target server 4.

The detection device 3 is connected between the firewall 2 and the attack target server 4, and detects the attack traffic. The detection device 3 is, for example, a computer on which at least one of software or hardware for monitoring traffic forwarded from the network 9 to the attack target server 4 is mounted. The detection device 3 determines whether the traffic is attack traffic by analyzing a communication amount, behavior, and the like of the traffic.

When detecting the attack traffic, the detection device 3 transmits, to a network management server, information (hereinafter referred to as “attack information”) of an address and a port indicating a destination and a transmission source of the attack traffic, and a protocol type of the attack traffic, in addition to a detection notification (see “attack detection”) of the attack traffic. When receiving the attack detection notification from the detection device 3, the NW management server 1x performs, for the firewall 2, defense settings against the attack traffic on the basis of the attack information.

The firewall 2 blocks, for example, the attack traffic on the basis of an address list 20 of the defense settings. In the address list 20, a transmission source address, a destination address, and processing content of the attack traffic are set. Addresses “A” and “D” of the attack source devices 7a and 7d are set as the transmission source addresses, an address “X” of the attack target server 4 is set as the destination address, and “block” is set as the processing content. Note that the processing content “block” means discarding the attack traffic having matched transmission source address and destination address.

Therefore, the attack traffic of the attack source device 7a is forwarded to the firewall 2 via the edge router (#1) 5 as illustrated by an arrow Ra but the attack traffic does not reach the attack target server 4. Furthermore, the attack traffic of the attack source device 7d is forwarded to the firewall 2 via the edge router (#4) 5 as illustrated by an arrow Rd but the attack traffic does not reach the attack target server 4. Thereby, an inflow of the attack traffic to the attack target server 4 is suppressed, and a load on the attack target server 4 is reduced.

However, the attack traffic of the attack source device 7a is transmitted in a section from the edge router (#1) 5 to the intermediate router (#5) 6 and a section from the intermediate router (#5) 6 to the firewall 2. Furthermore, the attack traffic of the attack source device 7d is transmitted in a section from the edge router (#4) 5 to the intermediate router (#6) 6 and a section from the intermediate router (#6) 6 to the firewall 2.

Therefore, a band of normal traffic forwarded from the external networks NWa to NWd through the edge routers (#1) 5 to (#4) 5 merges with the attack traffic at the intermediate router (#6) 6 to be compressed, and there is a possibility that the normal communication is disturbed.

To avoid it, if the edge routers (#1) 5 and (#4) 5 as the inflow sources of the attack traffic (hereinafter referred to as “inflow source router”) suppress the attack traffic, the edge routers can prevent compression of the band of other traffic. The edge router 5 and the intermediate router 6 can discard the attack traffic by registering address information of the attack traffic in an ACL on the basis of the attack information, for example.

However, since the edge router 5 and the intermediate router 6 determine a route to a forward destination of an IP packet by searching a routing table on the basis of the destination address of the IP packet, an inflow source router is not able to be specified from the information such as the transmission source address of the attack traffic.

Therefore, for example, the NW management server 1x performs attack traffic restriction settings for all the edge routers 5 in the network 9.

### Second Comparative Example

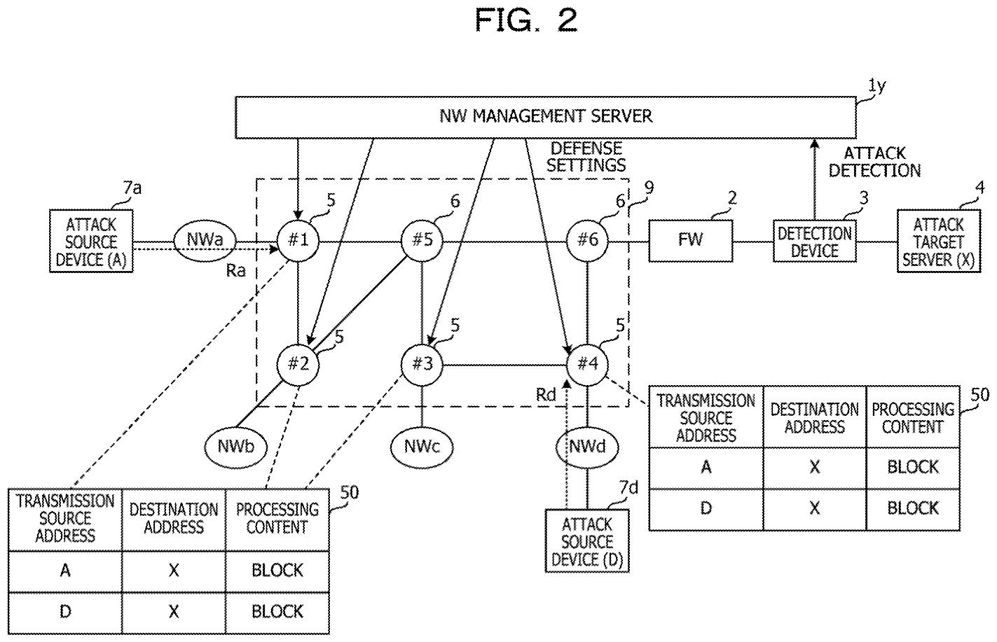

FIG. 2 is a configuration diagram illustrating a network system of a second comparative example. In FIG. 2, the same components as those in FIG. 1 are denoted by the same reference numerals, and description thereof will be omitted.

In the present example, an NW management server 1y manages the network 9, instead of the NW management server 1x. When receiving the detection notification of the attack traffic from the detection device 3, the NW management server 1y performs defense settings against the attack traffic for each of the edge routers 5. Thereby, content similar to the address list 20 in illustrated FIG. 1 is set in an ACL 50 of each edge router 5.

Therefore, the attack traffic of the attack source device 7a is restricted in forwarding at the edge router (#1) 5 and does not reach the intermediate router (#6) 6, as illustrated by the arrow Ra. Furthermore, the attack traffic of the attack source device 7d is restricted in forwarding at the edge router (#4) 5 and does not reach the intermediate router (#6) 6, as illustrated by the arrow Rd.

Therefore, the NW management server 1y does not need to specify the inflow source router and can suppress the attack traffic without compressing the band of other traffic.

However, according to this method, the defense settings against the attack traffic are performed for all the edge routers 5. Therefore, there is a possibility of an increase in a load of forward processing of other normal traffic in each edge router 5, for example.

### Embodiment

Therefore, an NW management server 1 according to an embodiment sets a communication route to another edge router 5 such that communication routes of traffic addressed to an attack target server 4 merge at the edge router 5 or the intermediate router 6, and performs defense settings for the merging edge router 5 or the intermediate router 6. For this reason, the number of routers for which the defense settings are to be set becomes smaller than the second comparative example. Therefore, the NW management server 1 can suppress an increase in a load of forward processing of other traffic due to the defense settings.

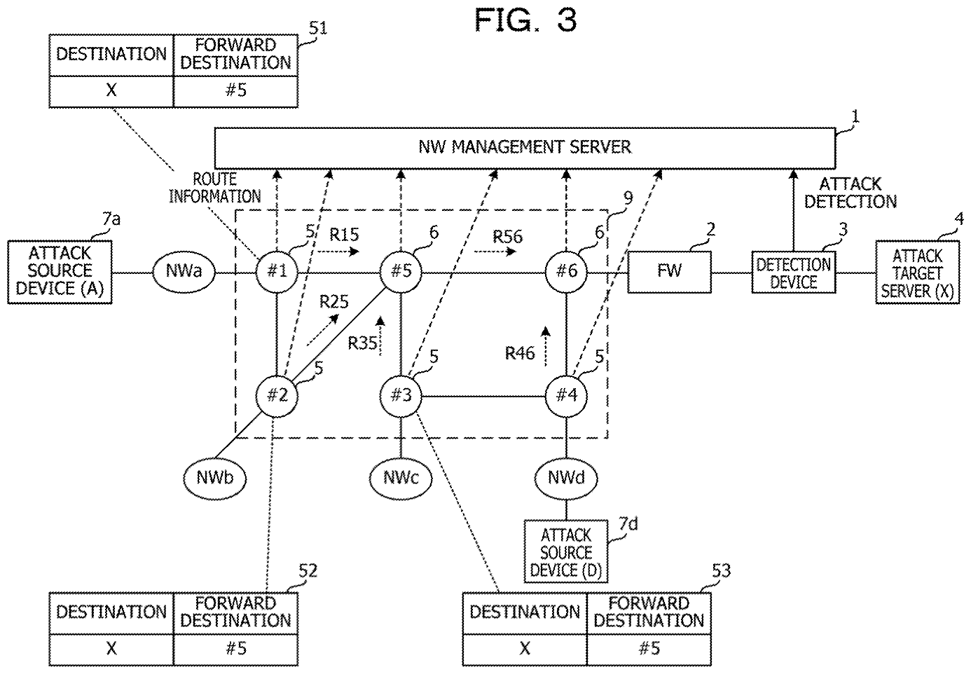

FIG. 3 is a diagram illustrating an example of an operation of collecting route information by the NW management server 1 according to the embodiment. In FIG. 3, the same components as those in FIG. 1 are denoted by the same reference numerals, and description thereof will be omitted. The NW management server 1 is an example of a network management device that manages a network 9. Note that a firewall 2 may not be provided in the present example.

When receiving a detection notification of attack traffic from a detection device 3, the NW management server 1 calculates a communication route R of traffic that each edge router 5 forwards to the attack target server 4. Therefore, for example, the NW management server 1 collects route information from each edge router 5 and each intermediate router 6. The route information is registered in, for example, a routing table of each edge router 5 and each intermediate router 6.

The route information each includes an identifier of a destination of the traffic, and identifiers #1 to #6 (NEX HOP) of the edge router 5 or the intermediate router 6 at a next forward destination. Note that the route information actually includes IP addresses of the destination and the forward destination. However, the NW management server 1 converts the IP addresses into identifiers and manages the identifiers. Therefore, here, the IP addresses will be described as identifiers.

As an example, route information 51 of the edge router (#1) 5 indicates a route setting in which the forward destination of the traffic addressed to an address “X” of the attack target server 4 is the intermediate router (#5) 6. Therefore, the edge router (#1) 5 forwards the traffic of the destination address “X” to the intermediate router (#5) 6 via a communication route R15 according to the route information 51.

Furthermore, the edge router (#2) 5 forwards the traffic of the destination address “X” to the intermediate router (#5) 6 via a communication route R25 according to route information 52. The edge router (#3) 5 forwards the traffic of the destination address “X” to the intermediate router (#5) 6 via a communication route R35 according to route information 53. Note that the other edge routers 5 and the intermediate routers 6 have route information similar to the route information 51 to 53.

The NW management server 1 calculates communication routes R15, R25, R35, R56, and R46 of traffic addressed to the attack target server 4 on the basis of the route information of each of the edge routers 5 and the intermediate routers 6. For example, the traffic forwarded from the edge router (#1) 5 to the attack target server 4 passes through the communication routes R15 and R56 passing through the intermediate routers (#5) 6 and (#6) 6.

Furthermore, for example, the traffic forwarded from the edge router (#4) 5 to the attack target server 4 passes through the communication route R46 passing through the edge router (#4) 5 and the intermediate routers (#6) 6. Note that the calculation method is not limited to the above method, and the NW management server 1 may calculate the communication route from route information input by an operator or from route information acquired from another database, for example.

The NW management server 1 performs route settings such that the communication routes merge at the edge router 5 or the intermediate router 6, and performs the defense settings for the edge router 5 or the intermediate router 6.

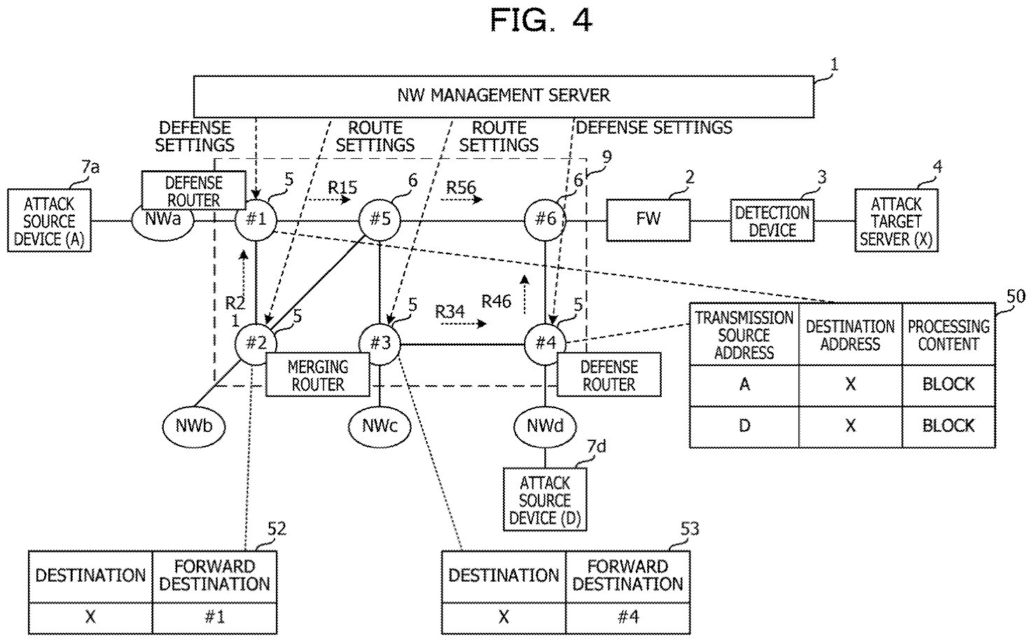

FIG. 4 is a diagram illustrating an operation example of performing the defense settings and route settings by the NW management server 1 according to the embodiment. In FIG. 4, the same components as those in FIG. 3 are denoted by the same reference numerals, and description thereof will be omitted.

The NW management server 1 sets the communication route for the edge router (#2) 5 such that the communication routes of traffic forwarded by the edge routers (#1) 5 and (#2) 5 to the attack target server 4 merge (see the “route settings”). The forward destination indicated by the route information 52 of the edge router (#2) 5 is set to the edge router (#1) 5 by the route settings.

The edge router (#2) 5 switches the forward destination of the traffic addressed to the attack target server 4 from the edge router (#3) 5 to the edge router (#2) 5 according to the route information 52. Therefore, the edge router (#2) 5 transmits the traffic addressed to the attack target server 4 to a communication route R21 headed to the edge router (#1) 5, instead of the communication route R25 (see FIG. 3) headed to the intermediate router (#5) 6.

Therefore, the traffic from the edge router (#2) 5 to the attack target server 4 passes through the communication routes R21, R15, and R56. Furthermore, the traffic from the edge router (#1) 5 to the attack target server 4 passes through the communication routes R15 and R56. Therefore, the communication routes R21, R15, and R56 from the edge router (#2) 5 and the communication routes R15 and R56 from the edge router (#1) 5 merge at the edge router (#1) 5. That is, the traffic of the edge router (#1) 5 and the traffic of the edge router (#2) 5 merge.

The NW management server 1 performs the defense settings for the edge router (#1) 5 at the merging position of the communication routes (see the “defense settings”). As a result, the edge router (#1) 5 suppresses forwarding of attack traffic. Note that content of an ACL 50 of the defense settings is as described above.

Furthermore, the NW management server 1 sets the communication route for the edge router (#3) 5 such that the communication routes of traffic forwarded by the edge routers (#3) 5 and (#4) 5 to the attack target server 4 merge (see the “route settings”). The forward destination indicated by the route information 53 of the edge router (#3) 5 is set to the edge router (#4) 5 by the route settings.

The edge router (#3) 5 switches the forward destination of the traffic addressed to the attack target server 4 from the intermediate router (#5) 6 to the edge router (#4) 5 according to the route information 53. Therefore, the edge router (#3) 5 transmits the traffic addressed to the attack target server 4 to a communication route R34 headed to the edge router (#4) 5, instead of the communication route R35 (see FIG. 3) headed to the intermediate router (#5) 6.

Therefore, the traffic from the edge router (#3) 5 to the attack target server 4 passes through the communication routes R34 and R46. Furthermore, the traffic from the edge router (#4) 5 to the attack target server 4 passes through the communication route R46. Therefore, the communication routes R34 and R46 from the edge router (#3) 5 and the communication route R46 from the edge router (#4) 5 merge at the edge router (#4) 5. That is, the traffic of the edge router (#3) 5 and the traffic of the edge router (#4) 5 merge.

The NW management server 1 performs the defense settings for the edge router (#4) 5 at the merging position of the communication routes (see the “defense settings”). As a result, the edge router (#4) 5 suppresses forwarding of attack traffic.

In this way, the NW management server 1 can collect the traffic addressed to the attack target server 4 to the edge router (#1) 5 by the route settings for the edge router (#2) 5, and can collect the traffic addressed to the attack target server 4 to the edge router (#4) 5 by the route settings for the edge router (#3) 5. The NW management server 1 performs the defense settings for the edge routers (#1) 5 and (#4) 5 where traffic are collected and does not perform the defense settings for the other edge routers (#2) 5 and (#3) 5.

Therefore, the NW management server 1 can reduce the number of edge routers 5 for which the defense settings are to be set as compared with the second comparative example. Therefore, the NW management server 1 can suppress an increase in a load of the forward processing of other traffic due to the defense settings.

Note that, in the following description, the edge router 5 for which the defense settings are to be set is referred to as “defense router” and the edge router 5 for which the route settings are to be set is referred to as “merging router”.

(Configuration of NW Management Server 1)

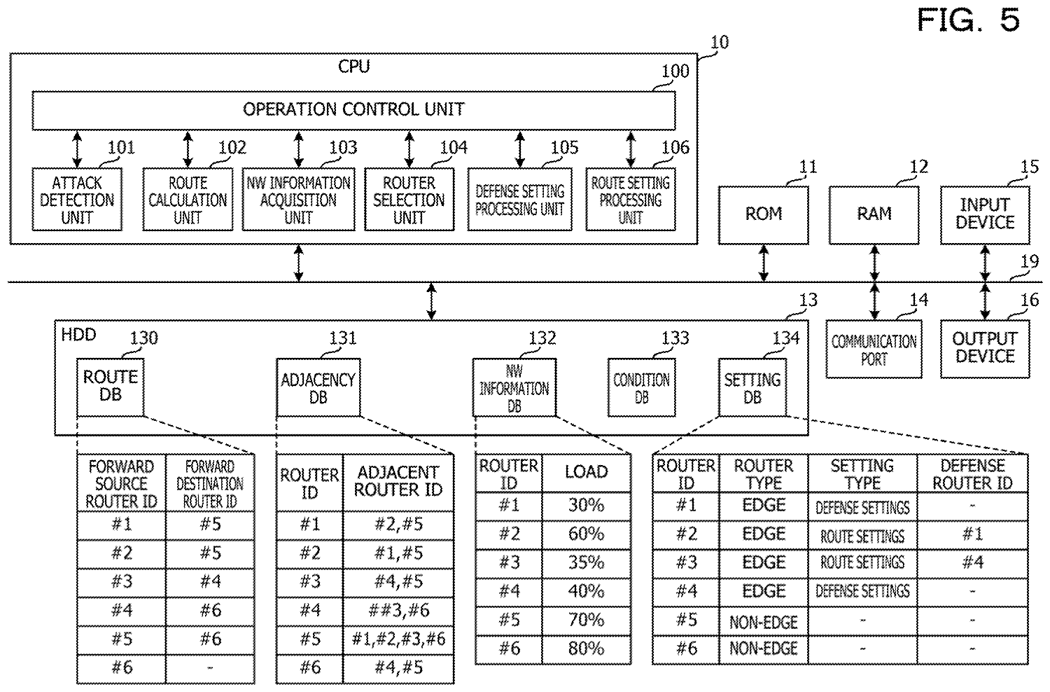

FIG. 5 is a configuration diagram illustrating an example of the NW management server 1. The NW management server 1 includes a central processing unit (CPU) 10, a read only memory (ROM) 11, a random access memory (RAM) 12, a hard disk drive (HDD) 13, a communication port 14, an input device 15, and an output device 16. The CPU 10 is connected to the ROM 11, the RAM 12, the HDD 13, the communication port 14, the input device 15, and the output device 16 via a bus 19 in such a manner that signals can be input to and output from one another.

The ROM 11 stores a program for driving the CPU 10. The RAM 12 functions as a working memory of the CPU 10. The communication port 14 is, for example, a wireless local area network (LAN) card or a network interface card (NIC), which processes communication between the edge router 5 and the CPU 10 and the intermediate router 6 and the CPU 10.

The input device 15 is a device for a user to input information to the CPU 10. Examples of the input device 15 include a keyboard, a mouse, a touch panel, and the like. The input device 15 outputs input information to the CPU 10 via the bus 19.

The output device 16 is a device for outputting information of the CPU 10 to the outside. Examples of the output device 16 include a display, a touch panel, and the like. The output device 16 obtains information from the CPU 10 via the bus 19, and outputs the information.

When reading the program from the ROM 11, the CPU 10 forms, as software functions, an operation control unit 100, an attack detection unit 101, a route calculation unit 102, a network (NW) information acquisition unit 103, a router selection unit 104, a defense setting processing unit 105, and a route setting processing unit 106. The operation control unit 100, the attack detection unit 101, the route calculation unit 102, the NW information acquisition unit 103, the router selection unit 104, the defense setting processing unit 105, and the route setting processing unit 106 may be formed as a circuit such as a field programmable gate array (FPGA) or an application specified integrated circuit (ASIC), for example, in addition to or instead of the software functions.

Furthermore, the HDD 13 stores a route database (DB) 130, an adjacency DB 131, a network (NW) information DB 132, a condition DB 133, and a setting DB 134. Note that a storage unit for the route DB 130, the adjacency DB 131, the NW information DB 132, the condition DB 133, and the setting DB 134 is not limited to the HDD 13, and may be another storage unit such as a memory instead of or together with the HDD 13.

The operation control unit 100 controls the entire operation of the NW management server 1. The operation control unit 100 instructs the attack detection unit 101, the route calculation unit 102, the NW information acquisition unit 103, the router selection unit 104, the defense setting processing unit 105, and the route setting processing unit 106 to perform operation according to a predetermined algorithm.

The attack detection unit 101 detects attack traffic according to the attack detection notification from the detection device 3. For example, the attack detection unit 101 receives the detection notification of the attack traffic and the attack information such as the transmission source address and the band of the attack traffic from the detection device 3 via the communication port 14. The attack detection unit 101 outputs the detection notification and the attack information of the attack traffic to operation control. Note that the attack detection unit 101 may directly detect the attack traffic from the traffic transmitted from the network 9 to the attack target server 4 by including a function similar to the detection device 3.

The route calculation unit 102 is an example of a calculation unit, and calculates each communication route of traffic forwarded from each edge router 5 to the attack target server 4. Therefore, the route calculation unit 102 acquires the route information from each edge router 5 and each intermediate router 6 via the communication port 14 (see FIG. 3). Note that the acquisition method is not limited to the above method and the route calculation unit 102 may acquire the route information input from the input device 15, for example.

The route calculation unit 102 registers the route information to the route DB 130. In the route DB 130, a forward source router ID and a forward destination router ID are registered. The forward source router ID is a router ID of the edge router 5 or the intermediate router 6 at the forward source of traffic, and the forward destination router ID is a router ID of the edge router 5 or the intermediate router 6 at the forward destination of traffic.

The route calculation unit 102 converts an IP address in the route information into the forward source router ID and the forward destination router ID. Note that, in a case where the forward destination is the detection device 3, “-” is registered as the forward destination router ID.

The route calculation unit 102 calculates the communication route of traffic addressed to the attack target server 4 by combining each route information in the route DB 130. For example, the route calculation unit 102 sequentially follows the forward destinations of the traffic from each edge router 5 to the attack target server 4 on the basis of the route information of each edge router 5 and each intermediate router 6 in the network 9.

The NW information acquisition unit 103 acquires NW information from each edge router 5 and each intermediate router 6. The NW information acquisition unit 103 requests each edge router 5 and each intermediate router 6 to transmit the NW information via the communication port 14. Each edge router 5 and each intermediate router 6 transmits the NW information to the NW management server 1 in response to the request from the NW information acquisition unit 103.

The NW information is, for example, a load (%) of the traffic forward processing of each edge router 5 and each intermediate router 6, and is used by the router selection unit 104 to select the defense router the merging router. Each edge router 5 and each intermediate router 6 transmits the load (%) of the CPU that executes the traffic forward processing.

The NW information acquisition unit 103 registers the NW information to the NW information DB 132. In the case where the NW information is the load of the traffic forward processing of each edge router 5 and each intermediate router 6, the router ID and the load are registered in the NW information DB 132, for example. For example, the load of the edge router (#1) 5 is 30(%).

The router selection unit 104 selects the defense router and the merging router from among each of the edge routers 5 and the intermediate routers 6 on the basis of the communication route calculated from the route DB 130 and the adjacency DB 131 such that a predetermined selection condition is satisfied and the traffic does not loop. Note that the defense router is an example of a first router and the merging router is an example of a second router.

The selection condition is an example of a condition regarding the load of the traffic forward processing in the network 9. For example, in a case of using the selection condition in which the load of the traffic forward processing of the defense router is equal to or less than a threshold value, the router selection unit 104 selects the defense router on the basis of the NW information DB 132 indicating the load.

In a case where the threshold value of the load is 50(%), the router selection unit 104 sets the defense router from among the edge routers (#1) 5, (#3) 5, and (#4) 5 having the load of 50(%) or less on the basis of the NW information DB 132. Moreover, the router selection unit 104 finally selects the defense router according to a priority condition giving priority to the edge router 5 and the intermediate router 6 having a low load. The selection condition and the priority condition are registered in the condition DB 133. Note that variations of the selection condition and the priority condition will be described below.

As a result, the router selection unit 104 can select the defense router having the least load. Therefore, even if the defense router suppresses the attack traffic due to the defense settings, the defense router still has a margin for the load of the forward processing. Therefore, the defense router can suppress influence on the load of the forward processing of traffic in the network 9.

Furthermore, the router selection unit 104 selects the merging router that does not allow the traffic to loop between the merging router and the defense router from among the edge routers 5 for which the communication route headed to the defense router can be set on the basis of the communication route and the adjacency DB 131. Therefore, the edge router 5 prevents the traffic from being unable to reach the attack target server 4 due to the route settings. Note that, in a case where the communication route headed to the defense router can be set and there is no edge router 5 that satisfies the selection condition, the router selection unit 104 does not select the merging router and selects only the defense router. Note that the router selection unit 104 is an example of a selection unit.

The adjacency DB 131 is information indicating an adjacency between each edge router 5 and each intermediate router 6. A router ID and an adjacent router ID are registered in the adjacency DB 131. The adjacent router ID is router IDs of the edge router 5 and each intermediate router 6 adjacent to the edge router 5 or each intermediate router 6 indicated by the router ID. For example, the edge router (#1) 5 is adjacent to the edge router (#2) 5 and the intermediate router (#5) 6.

For example, the operation control unit 100 registers connection information of each edge router 5 and each intermediate router 6 in the network 9, which has been input from the input device 15 in advance, to the adjacency DB 131. Note that the adjacency indicated by the adjacency DB 131 is an example of a connection relationship between each edge router 5 and each intermediate router 6.

The router selection unit 104 sets the setting DB 134 on the basis of the selected defense router and merging router. A router ID, a router type, a setting type, and a defense router ID are registered in the setting DB 134. The router type indicates which of the edge router 5 (“edge”) or the intermediate router 6 (non-edge) the router indicated by the router ID is. The setting type indicates a type of settings (the defense settings, route settings, or no settings (“-”)) performed for the edge router 5 or the intermediate router 6 indicated by the router ID. The defense router ID is the router ID of the defense router corresponding to the merging router in a case of a router with the setting type of the route settings, that is, in the case of the merging router.

For example, the operation control unit 100 registers the router ID and the router type of the setting DB 134 on the basis of configuration information in the network 9 input from the input device 15 in advance. Furthermore, the router selection unit 104 registers the setting type and the defense router ID of the setting DB 134.

The router selection unit 104 registers the defense settings to the setting type corresponding to the router ID of the defense router, and registers the route settings to the setting type corresponding to the router ID of the merging router. Moreover, the router selection unit 104 registers the router ID of the defense router to the defense router ID corresponding to the router ID of the merging router.

In the case of the example in FIG. 4, since the router selection unit 104 selects the edge routers (#1) 5 and (#4) 5 as the defense routers, the router selection unit 104 registers the defense settings to the setting types of the router IDs “#1” and “#4” of the setting DB 134. Furthermore, since the router selection unit 104 selects the edge routers (#2) 5 and (#3) 5 as the merging routers, the router selection unit 104 registers the route settings to the setting types of the router IDs “#2” and “#3” of the setting DB 134. Furthermore, since the combination of the edge routers (#1) 5 and (#2) 5 and the combination of the edge routers (#4) 5 and (#3) 5 are the combinations of the defense router and the merging router, the router selection unit 104 registers the defense router IDs “#1” and “#4” corresponding to the router IDs “#2” and “#3” of the setting DB 134.

Furthermore, the defense setting processing unit 105 is an example of an instruction unit, and instructs the defense router to suppress forwarding of attack traffic. For example, the defense setting processing unit 105 transmits the information of the defense settings to the defense router via the communication port 14 on the basis of the setting DB 134. For example, the defense setting processing unit 105 performs the defense settings for the edge routers (#1) 5 and (#4) 5 in which the setting type of the setting DB 134 is the defense settings. As a result, the ACL 50 of the edge routers (#1) 5 and (#4) 5 is set as illustrated in FIG. 4

The route setting processing unit 106 is an example of a setting unit, and sets a communication route of traffic for the merging router such that communication routes merge at the defense router. For example, the route setting processing unit 106 transmits the route information for the route settings to the merging router via the communication port 14 on the basis of the setting DB 134. For example, the route setting processing unit 106 performs the route settings for the edge routers (#2) 5 and (#3) 5 in which the setting type of the setting DB 134 is the route settings.

Thereby, in the case of the example in FIG. 4, the edge routers (#2) 5 and (#3) 5 switch a route to an output destination of traffic addressed to the attack target server to the communication routes R21 and R34 by updating the route information. Therefore, the traffic addressed to the attack target server is transmitted to the edge routers (#1) 5 and (#4) 5 and merges with the traffic addressed to another attack target server 4.

Setting examples of the defense router and the merging router will be described below.

### First Setting Example

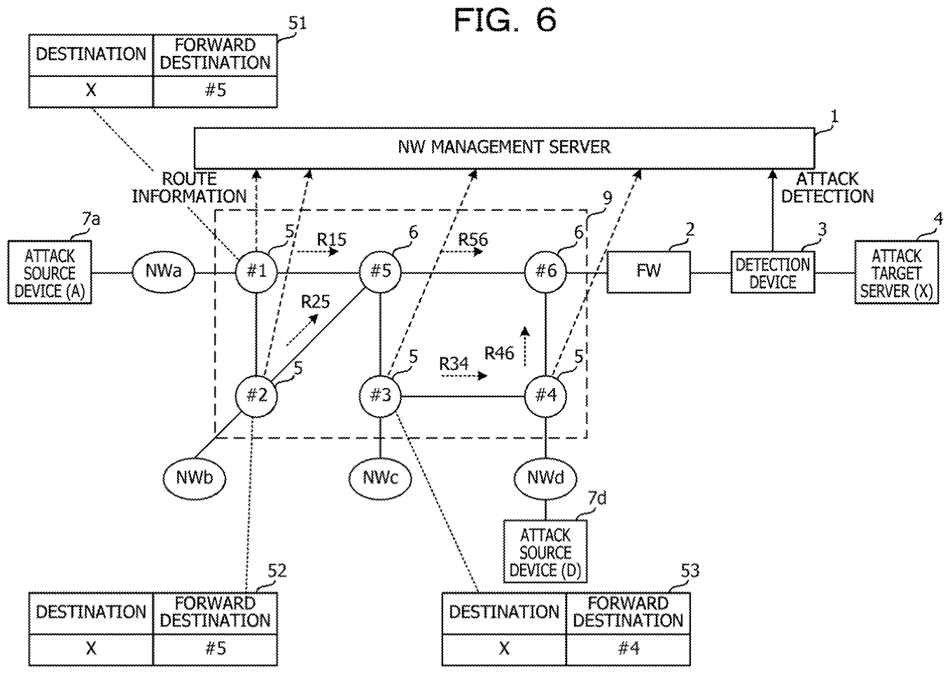

FIG. 6 is a diagram illustrating an operation of acquiring route information in a first setting example. In FIG. 6, the same components as those in FIG. 3 are denoted by the same reference numerals, and description thereof will be omitted.

In the present example, the edge router (#3) 5 forwards the traffic addressed to the attack target server 4 to the edge router (#4) 5 via the communication route R34, unlike the example in FIG. 3. The route information 53 of the edge router (#3) 5 indicates the edge router (#4) 5 as the forward destination of the traffic with the address “X”.

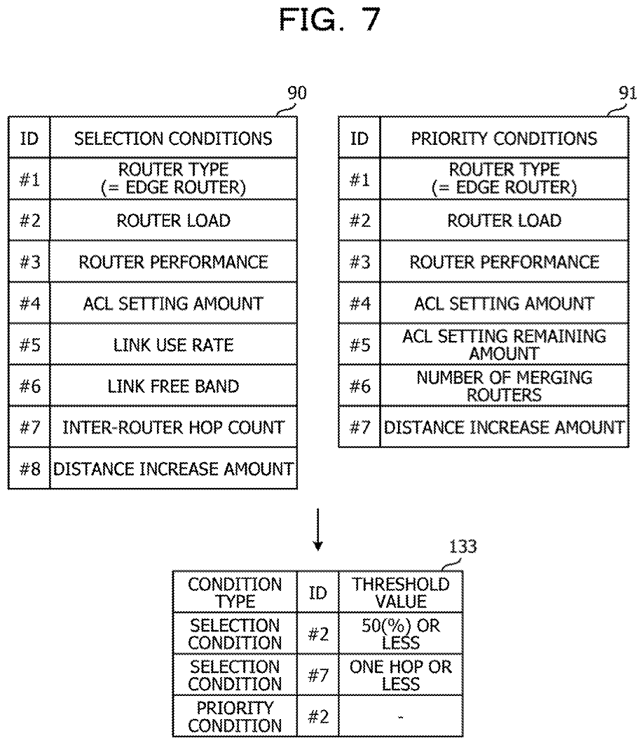

FIG. 7 is a diagram illustrating lists 90 and 91 of the selection conditions and the priority conditions and an example of the condition DB 133. For example, the user selects one or more selection conditions and priority conditions from the list 90 of the selection conditions and the list 91 of the priority conditions displayed on the output device 16.

The selection condition is a condition for selecting candidates for the defense router or candidates for a combination of the defense router and the merging router from among the edge routers 5 and the intermediate routers 6. Furthermore, the priority condition is a condition for finally determining the defense router or a combination of the defense router and the merging router from among the candidates for the defense router or the candidates for a combination of the defense router and the merging router. Note that the selection condition and the priority condition have the same content.

IDs “#1” to “#8” are given to the respective selection conditions in the list 90. Furthermore, IDs “#1” to “#7” are given to the priority conditions in the list 91. The user selects one or more selection condition IDs and one or more priority condition IDs. The operation control unit 100 generates the condition DB 133 according to the IDs selected by the user and input from the input device.

The selection condition “router type” of the ID “#1” is that the defense router is one of the edge routers 5. As described with reference to FIG. 1, the defense router is desirably the edge router 5 so that the band of normal traffic other than attack traffic is not compressed. Therefore, according to the present priority condition, the edge router 5 is selected as the defense router.

The selection condition “router load” of the ID “#2” is that the load of the traffic forward processing of the defense router is equal to or less than a threshold value. The edge router 5 and the intermediate router 6 are not able to detect and discard attack traffic quickly when the load of the forward processing is high. Therefore, the edge router 5 and the intermediate router 6 having a high load are excluded from the candidates for the defense router according to the present selection condition.

The selection condition “router performance” of the ID “#3” is that an index value of the level of performance of the traffic forward processing of the defense router is equal to or larger than a threshold value. The edge router 5 and the intermediate router 6 are not able to detect and discard attack traffic quickly when the performance of the forward processing is low. Therefore, the edge router 5 and the intermediate router 6 with low performance are excluded from the candidates for the defense router according to the present selection condition.

The selection condition “ACL setting amount” of the ID “#4” is that a setting amount of the ACL 50 of the defense router is equal to or less than a threshold value. Settings for preventing an inflow of undesired traffic such as attack traffic are registered in the ACL 50. The edge router 5 and the intermediate router 6 detect the corresponding traffic by searching the ACL 50 on the basis of the transmission source address and the destination address of the traffic, for example.

Therefore, the edge router 5 and the intermediate router 6 take more time for traffic search processing and are not able to detect and discard attack traffic quickly as the setting amount of the ACL 50 is larger. Therefore, the edge router 5 and the intermediate router 6 with a large setting amount are excluded from the candidates for the defense router according to the present selection condition.

The selection condition “link use rate” of the ID “#5” is that a band use rate of each link between the defense router and the merging router is equal to or less than a threshold value. Since other normal traffic is more compressed as the use rate of a link in which attack traffic flows is higher, the edge router 5 and the intermediate router 6 connected by the link with a high use rate are excluded from the candidates for a combination of the defense router and the merging router according to the present selection condition.

The selection condition “link free band” of the ID “#6” is that a free band of each link between the defense router and the merging router is equal to or less than a threshold value. Since other normal traffic is more compressed as the free band of the link in which attack traffic flows is smaller, the edge router 5 and the intermediate router 6 connected by the link with a smaller free band are excluded from the candidates for a combination of the defense router and the merging router according to the present selection condition.

The selection condition “inter-router hop count” of the ID “#7” is that the number of hops between the defense router and the merging router is equal to or less than or a threshold value. Note that the number of hops is an example of distance. Since other normal traffic is more compressed as the distance in which the attack traffic flows is longer, the edge router 5 and the intermediate router 6 having a long distance from each other are excluded from the candidates for a combination of the defense router and the merging router according to the present selection condition.

The selection condition “distance increase amount” of the ID “#8” is that an increase amount in the number of hops from the merging router to the attack target server 4 due to the route settings is equal to or less than a threshold value. Note that the number of hops is an example of indicating for distance. Not only the communication route of the attack traffic but also the communication route of normal traffic is changed by the route settings. The number of edge routers 5 or intermediate routers 6 that forward the normal traffic increases as the distance in which the normal traffic flows is longer. Therefore, the edge router 5 and the intermediate router 6 having a distance to the attack target server 4, the distance greatly increasing, are excluded from the candidates for a combination of the defense router and the merging router according to the present selection condition.

The priority condition “router type” of the ID “#1” is to give priority to an edge router 5 in selecting the defense router. As described with reference to FIG. 1, the defense router is desirably the edge router 5 so that the band of normal traffic other than attack traffic is not compressed. Therefore, according to the present priority condition, the edge router 5 is preferentially selected as the defense router.

The priority condition “router load” of the ID “#2” is to give priority to the edge router 5 and the intermediate router 6 having a low load of the traffic forward processing in selecting the defense router. The edge router 5 and the intermediate router 6 are not able to detect and discard attack traffic quickly when the load of the forward processing is high. Therefore, the edge router 5 and the intermediate router 6 having a low load are preferentially selected as the defense routers according to the present priority condition.

The priority condition “router performance” of the ID “#3” is to give priority to the edge router 5 and the intermediate router 6 having a high index value of the level of the performance of the traffic forward processing in selecting the defense router. The edge router 5 and the intermediate router 6 are not able to detect and discard attack traffic quickly when the performance of the forward processing is low. Therefore, the edge router 5 and the intermediate router 6 having high performance are preferentially selected as the defense routers according to the present priority condition.

The priority condition “ACL setting amount” of the ID “#4” is to give priority to the edge router 5 and the intermediate router 6 having a small setting amount of the ACL 50 in selecting the defense router. The edge router 5 and the intermediate router 6 take more time for the traffic search processing and are not able to detect and discard attack traffic quickly as the setting amount of the ACL 50 is larger. Therefore, the edge router 5 and the intermediate router 6 having a small setting amount are preferentially selected as the defense routers according to the present priority condition.

The priority condition “ACL setting remaining amount” of the ID “#5” is to give priority to the edge router 5 and the intermediate router 6 having a large remaining setting amount of the ACL 50 in selecting the defense router. The edge router 5 and the intermediate router 6 take more time for the traffic search processing and are not able to detect and discard attack traffic quickly as the setting amount of the ACL 50 is larger. Therefore, the edge router 5 and the intermediate router 6 having a large remaining setting amount are preferentially selected as the defense routers according to the present priority condition.

The priority condition “the number of merging routers” of the ID “#6” is to give priority to the edge router 5 and the intermediate router 6 having a large number of merging routers when selected as the defense routers in selecting the defense routers. Since the number of defense routers in the network 9 decreases as the number of merging routers capable of forwarding the traffic to one defense router is larger, the edge router 5 and the intermediate router 6 having a large number of merging routers when selected as the defense routers are preferentially selected according to the present priority condition.

The priority condition “distance increase amount” of the ID “#7” is that an increase amount in the number of hops from the merging router to the attack target server 4 due to the route settings is equal to or less than a threshold value. Note that the number of hops is an example of indicating for distance. The number of edge routers 5 or intermediate routers 6 that forward the normal traffic increases as the distance in which the normal traffic flows is longer. Therefore, the edge router 5 and the intermediate router 6 having a distance to the attack target server 4, the distance greatly increasing, are excluded from the candidates for a combination of the defense router and the merging router according to the present priority condition.

As described above, the selection conditions and the priority conditions are related to the load of the traffic forward processing in the network 9. Therefore, the router selection unit 104 selects the defense router or a combination of the defense router and the merging router according to the selection condition and the priority condition, thereby reducing the load of the traffic forward processing.

In the present example, the user selects the selection condition “router load” of the ID “#2”, the selection condition “inter-router hop count” of the ID “#7”, and the priority condition “router load” of the ID “#2” from the lists 90 and 91. The operation control unit 100 registers the selected selection conditions and priority condition to the condition DB 133. Note that the threshold value of each selection condition is not limited and may be set in advance by the user or may be a fixed value.

The condition type, ID, and threshold value are registered in the condition DB 133. The condition type indicates either a selection condition or a priority condition. The ID is an ID of the selection condition or the priority condition. The threshold value is a threshold value used for the selection condition.

In the present example, the router selection unit 104 extracts the candidates for the defense router from among the edge routers 5 and the intermediate routers 6 having the load of 50(%) or less according to the selection condition “router load” of the ID “#2”. Moreover, the router selection unit 104 selects the final defense router from among the candidates for the defense router according to the priority condition “router load” of the ID “#2”.

Furthermore, the router selection unit 104 selects the merging router from among the edge routers 5 at the distance of one hop or less to the defense router according to the selection condition “inter-router hop count” of the ID “#7”. The selection method will be described below.

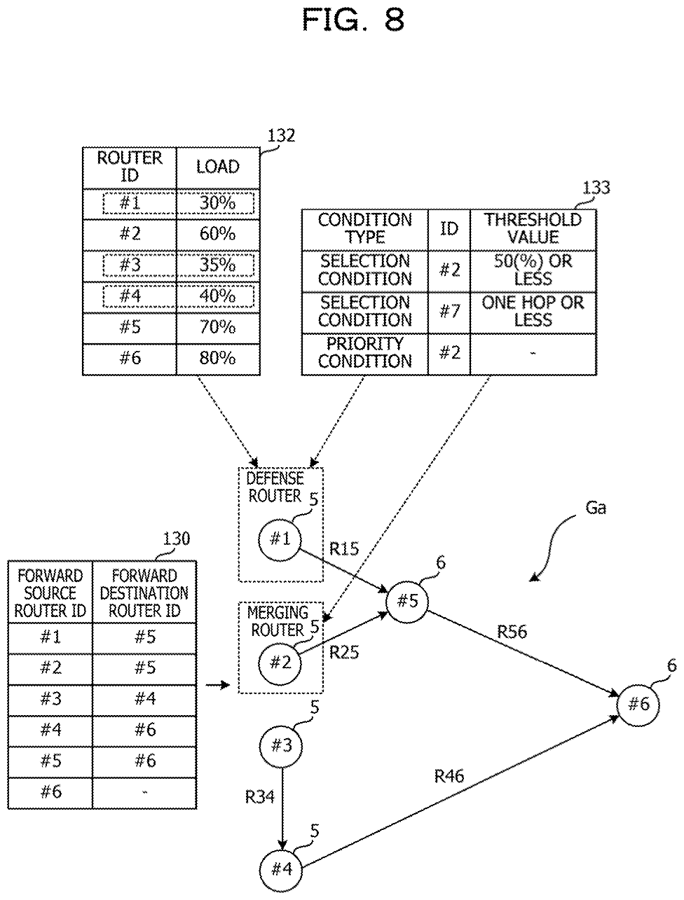

FIG. 8 is a diagram (No. 1) illustrating the method of selecting the defense router and the merging router in the first setting example. The router selection unit 104 generates a graph Ga of the communication routes R15, R25, R56, R34, and R46 of the traffic based on the route DB 130.

The router selection unit 104 extracts candidates for the defense router from among the edge routers 5 and the intermediate routers 6 on the graph Ga according to the selection condition “router load” of the ID “#2”. The router selection unit 104 extracts the edge routers (#1) 5, (#3) 5, and (#4) 5 having the load of 50(%) or less as the candidates for the defense router from the NW information DB 132. Moreover, the router selection unit 104 selects the edge router (#1) 5 having the lowest load as the defense router from among the candidates for the defense router (see the dotted frame) according to the priority condition “router load” of the ID “#2”.

Furthermore, the router selection unit 104 selects the merging router from among the edge routers 5 at the distance of one hop or less to the defense router on the basis of the adjacency DB 131 according to the selection condition “inter-router hop count” of the ID “#7”. The router selection unit 104 selects the edge router (#2) 5 having the distance of one hop from the edge router (#1) 5 selected as the defense router, as the merging router. The route settings are performed for the edge router (#2) 5 such that the communication route merges with the edge router (#1) 5 as the defense router.

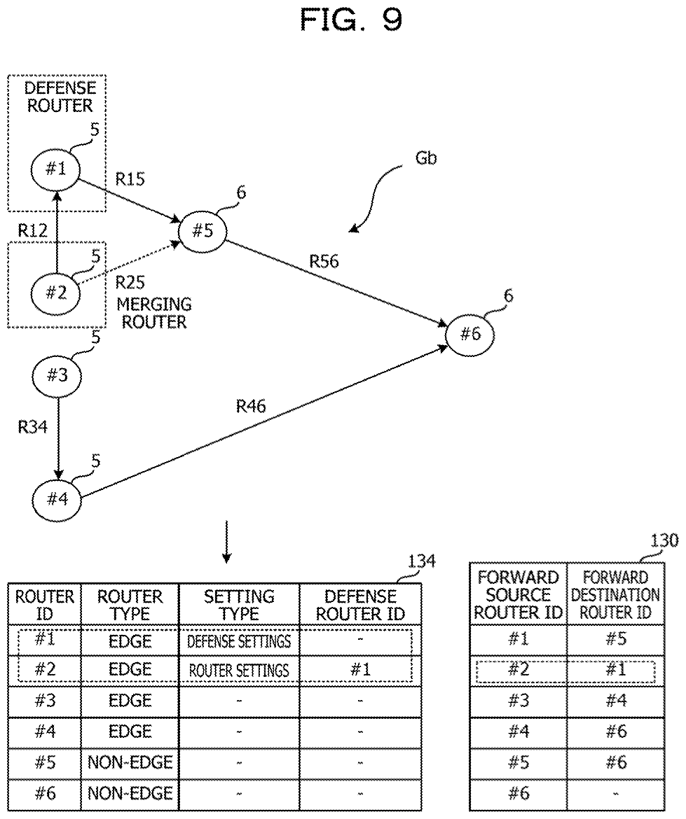

FIG. 9 is a diagram (No. 1) illustrating the route DB 130 and the setting DB 134 at the time of route settings in the first setting example. A graph Gb illustrates the communication routes R12, R15, R56, R34, and R46 of the traffic after the route settings for the edge router (#2) 5. The communication route R25 of the edge router (#2) 5 as the merging router is switched to the communication route R12 toward the defense router.

The router selection unit 104 determines whether the traffic loops between the defense router and the merging router from the communication routes R12 and R15. Since the traffic loop relationship is not established between the defense router and the merging router, the router selection unit 104 updates the route DB 130 and registers the setting DB 134.

The router selection unit 104 updates the route DB 130 according to the switching of the communication route. Thereby, the forward destination router ID of the forward source router ID “#2” is updated from “#5” to “#1”.

Furthermore, the router selection unit 104 registers the defense router and the merging router to the setting DB 134 according to the selection result of the defense router and the merge router. Thereby, the defense settings are registered in the setting type of the router ID “#1”, and the route settings are registered in the setting type of the router ID “#2”. Furthermore, “#1” is registered in the defense router ID of the router ID “#2”.

The router selection unit 104 selects all the edge routers 5 in the network 9 as the defense routers or merging routers. Therefore, the router selection unit 104 selects the defense router and the merging router from the remaining edge routers (#3) 5 and (#4) 5.

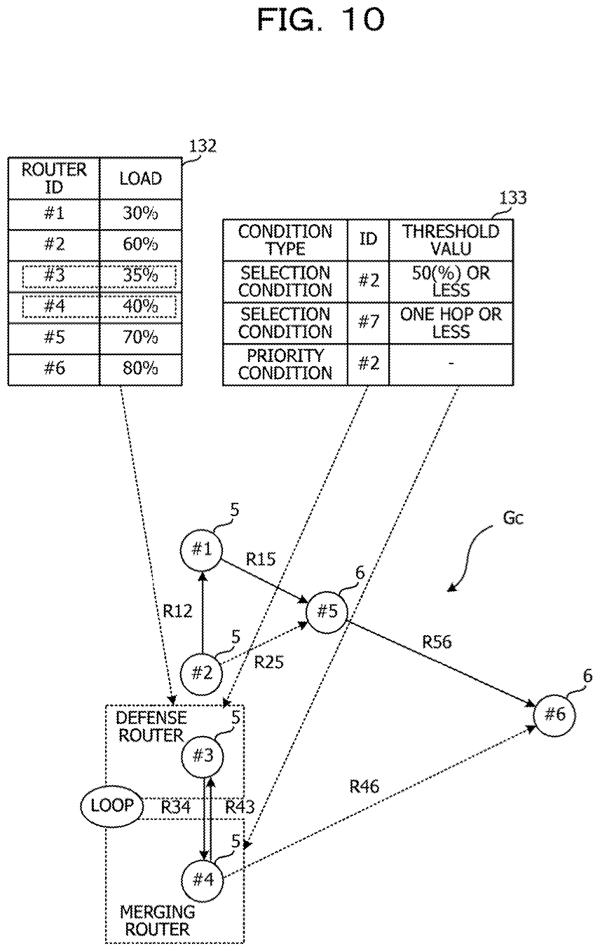

FIG. 10 is a diagram (No. 2) illustrating the method of selecting the defense router and the merging router in the first setting example. The router selection unit 104 selects the edge router (#3) 5 having the lowest load as the defense router from among the remaining candidates for the defense router (see the dot ted frame) according to the priority condition “router load” of the ID “#2”.

Furthermore, the router selection unit 104 selects the merging router from among the edge routers 5 at the distance of one hop or less to the defense router on the basis of the adjacency DB 131 according to the selection condition “inter-router hop count” of the ID “#7”. Here, only the edge router (#4) 5 remains as the candidate for the merging router, and the distance to the edge router (#3) 5 and the edge router (#4) 5 is one hop from the adjacency DB 131.

Therefore, the router selection unit 104 selects the edge router (#4) 5 as the merging router. The route settings are performed for the edge router (#2) 5 such that the communication route merges with the edge router (#1) 5 as the defense router.

A graph Gc illustrates the communication routes R12, R15, R56, R34, and R43 of the traffic after the route settings for the edge router (#2) 5. Here, the communication route R46 of the edge router (#4) 5 as a merging router is switched to the communication route R43 toward the defense router.

The router selection unit 104 determines whether the traffic loops between the defense router and the merging router from the communication routes R34 and R43. Since the traffic loop relationship is established between the defense router and the merging router, the router selection unit 104 reselects the defense router. Therefore, the router selection unit 104 selects the edge router (#4) 5 having the second lowest load as the defense router according to the priority condition “router load” of the ID “#2”.

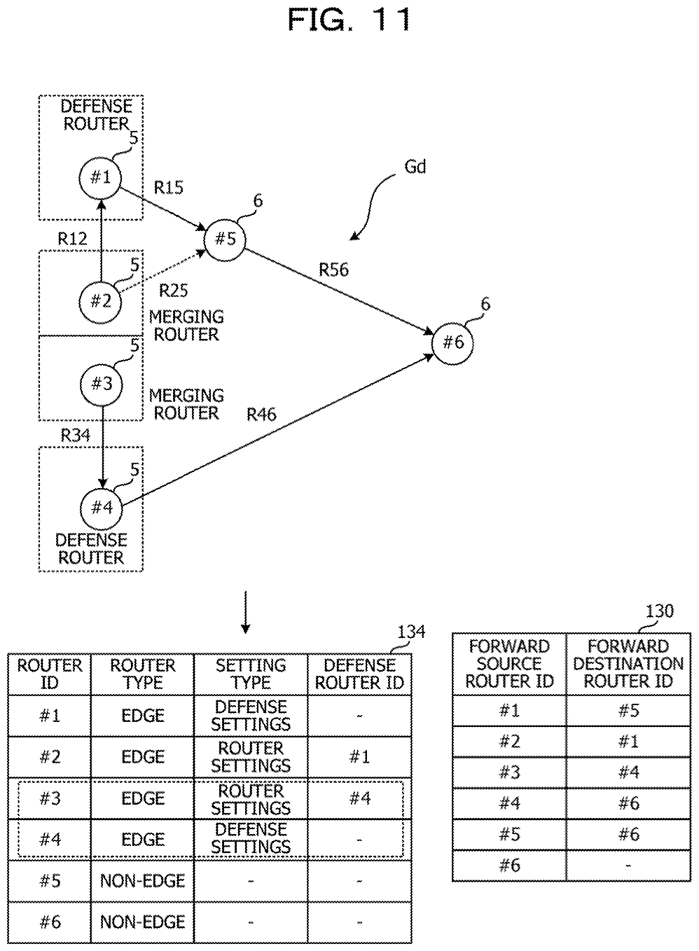

FIG. 11 is a diagram (No. 2) illustrating the route DB 130 and the setting DB 134 at the time of route settings in the first setting example. A graph Gd illustrates the communication routes R12, R15, R56, R34, and R46 of the traffic after the route settings for the edge router (#2) 5. Note that, in the present example, the communication route R34 of the edge router (#3) 5 as the merging router does not change before and after the route settings.

The router selection unit 104 determines whether the traffic loops between the defense router and the merging router from the communication routes R34 and R46. Since the traffic loop relationship is not established between the defense router and the merging router, the router selection unit 104 updates the route DB 130 and registers the setting DB 134. Note that, in the present example, since the communication route of the edge router (#3) 5 as the merging router does not change, the content of the route DB 130 is unchanged before and after the update.

The router selection unit 104 registers the defense router and the merging router to the setting DB 134 according to the selection result of the defense router and the merge router. Thereby, the defense settings are registered in the setting type of the router ID “#4”, and the route settings are registered in the setting type of the router ID “#3”. Furthermore, “#4” is registered in the defense router ID of the router ID “#3”.

In this way, the router selection unit 104 selects a combination of the defense router and the merging router.

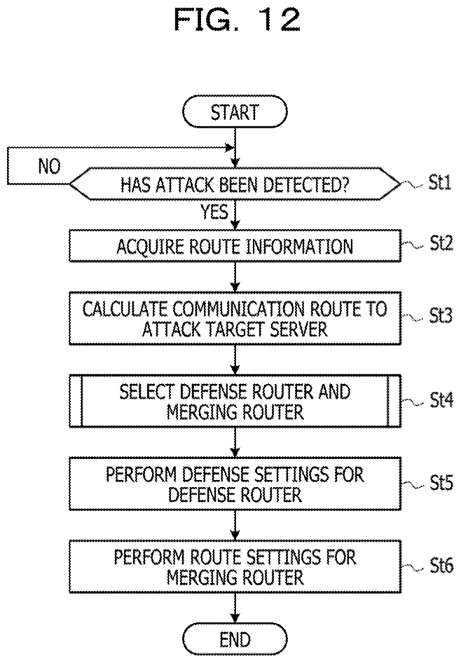

FIG. 12 is a flowchart illustrating an example of the operation of the NW management server 1. The attack detection unit 101 determines whether attack traffic has been detected on the basis of the detection notification from the detection device 3 (step St1). In a case where the attack traffic has not been detected (No in step St1), the processing of step St1 is executed again.

Next, the route calculation unit 102 acquires the route information from the edge routers 5 and the intermediate routers 6 (step St2). At this time, the route calculation unit 102 registers the route information to the route DB 130. Next, the route calculation unit 102 calculates the communication route of the traffic addressed to the attack target server 4 on the basis of the route DB 130 (step St3).

Next, the router selection unit 104 selects a combination of the defense router and the merging router (step St4). Note that the selection processing will be described below. Next, the defense setting processing unit 105 performs the defense settings for the defense router (step St5). Next, the route setting processing unit 106 performs the route settings for the merging router (step St6). The NW management server 1 operates in this manner.

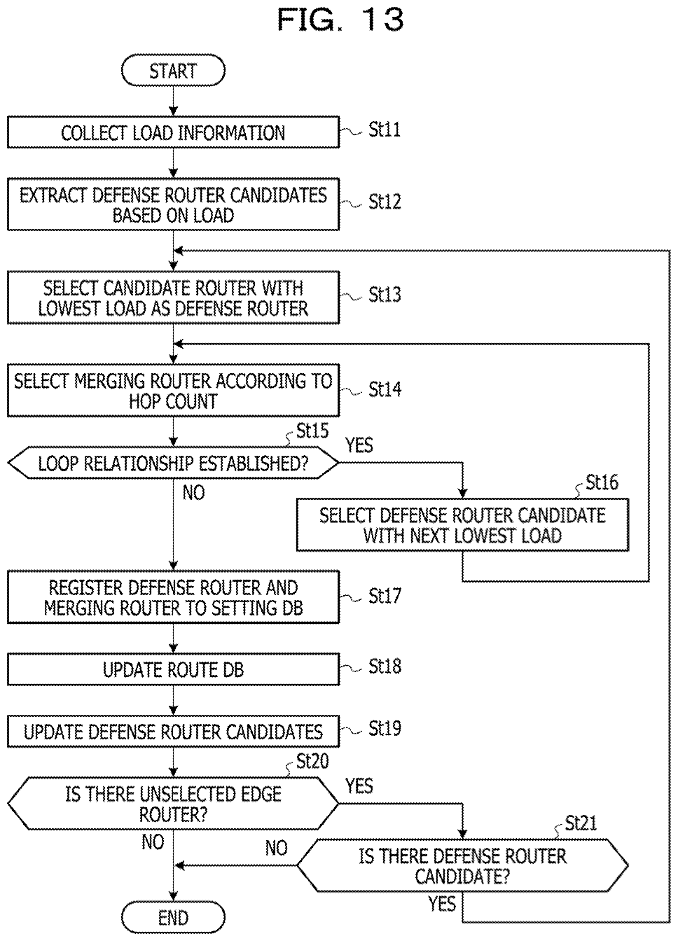

FIG. 13 is a flowchart of the selection processing for selecting the defense router and the merging router in the first setting example. The selection processing is executed in step St4 described above.

The NW information acquisition unit 103 acquires load information from the edge routers 5 and the intermediate routers 6 according to the selection condition “router load” of the ID “#2” and the priority condition “router load” of the ID “#2” registered in the condition DB 133 (step St11). At this time, the NW information acquisition unit 103 registers the load information to the NW information DB 132.

Next, the router selection unit 104 extracts the edge routers 5 and the intermediate routers 6 having the load of 50(%) or less as the candidates for the defense router from the NW information DB 132 according to the selection condition “router load” of the ID “#2” (step St12). Next, the router selection unit 104 selects the edge router 5 having the lowest load as the defense router from among the candidates for the defense router according to the priority condition “router load” of the ID “#2” (step St3).

Next, the router selection unit 104 selects the merging router from among the edge routers 5 at the distance of one hop or less to the defense router on the basis of the adjacency DB 131 according to the selection condition “inter-router hop count” of the ID “#7” (step St14). At this time, the router selection unit 104 does not select the merging router in the case where there is no unselected edge router 5 for which the communication route headed to the defense router can be set.

Next, the router selection unit 104 determines whether the traffic loop relationship is established between the defense router and the merging router from the communication route of the traffic addressed to the attack target server 4 (step St15). In the case where the loop relationship is established (Yes in step St15), the router selection unit 104 selects the edge router 5 having the next lowest such as second lowest load as the defense router from among the candidates for the defense router (step St16). Thereafter, the processing of step St4 and the subsequent steps is performed again.

In the case where the loop relationship is not established (No in step St15), the router selection unit 104 registers the information of the defense router and the merging router to the setting DB 134, as described above (step St17). Next, the router selection unit 104 updates the route DB 130 according to the communication route of the merging router (step St18).

Next, the router selection unit 104 updates the candidates for the defense router according to the selection result of the defense router and the merging router (step St19). Thereby, the selected edge router 5 and intermediate router 6 are excluded from the candidates.

Next, the router selection unit 104 determines the presence of an unselected edge router 5 as the defense router or the merging router (step St20). In the case where there is no unselected edge router 5 (No in step St20), the processing is terminated. Furthermore, in the case where there is an unselected edge router 5 (Yes in step St20), the presence of a candidate for the defense router is determined (step St21).

In the case where there is a candidate (Yes in step St21), the processing of step St3 and the subsequent steps is executed again. In the case where there is no candidate (No in step St21), the processing is terminated. In this way, the selection processing is executed.

In this way, the router selection unit 104 selects the edge router 5 and the intermediate router 6 having the load of 50(%) or less as the defense routers so that the selection condition “router load” of the ID “#2” is satisfied. Therefore, even if the defense router suppresses the attack traffic due to the defense settings, the defense router still has a margin for the load of the forward processing. Therefore, the defense router can suppress influence on the load of the forward processing of traffic in the network 9.

Furthermore, the router selection unit 104 selects the merging router from among the edge routers 5 at the distance of one hop or less to the defense router so that the selection condition “inter-router hop count” of the ID “#7” is satisfied. Therefore, the distance in which the attack traffic flows is shortened, and compression of other normal traffic can be reduced.

### Second Setting Example

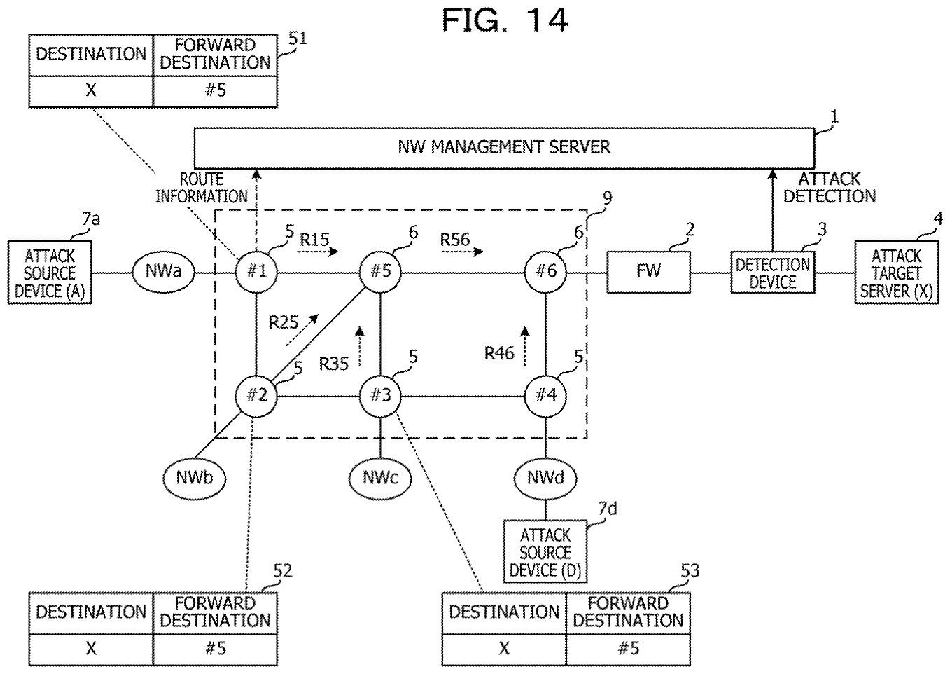

FIG. 14 is a diagram illustrating an operation of acquiring route information in a second setting example. In FIG. 14, the same components as those in FIG. 6 are denoted by the same reference numerals, and description thereof will be omitted.

In the present example, the edge router (#3) 5 forwards the traffic addressed to the attack target server 4 to the intermediate router (#5) 6 via the communication route R35, unlike the example in FIG. 6. The route information 53 of the edge router (#3) 5 indicates the intermediate router (#5) 6 as the forward destination of the traffic with the address “X”. Furthermore, the edge routers (#2) 5 and (#3) 5 are connected via a link, unlike the example in FIG. 6.

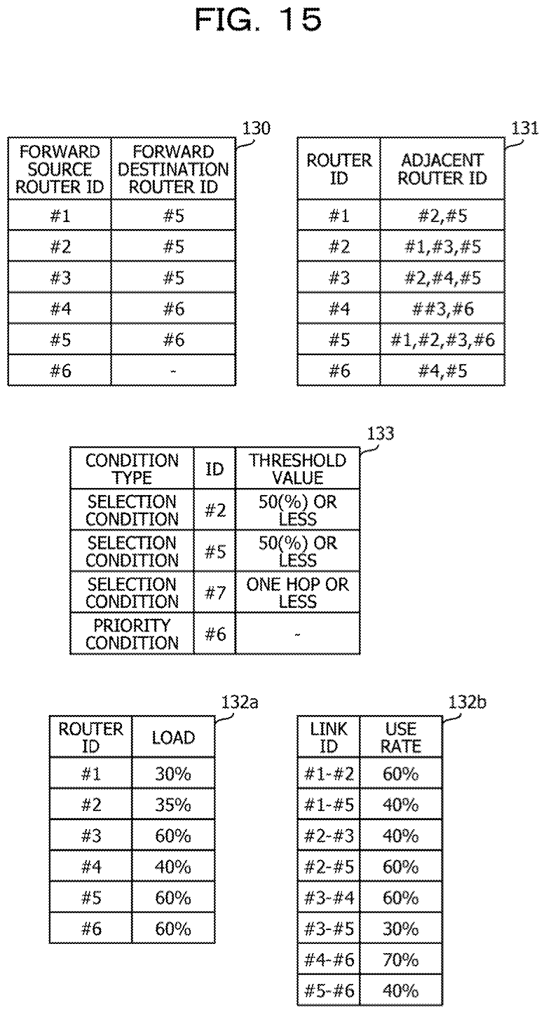

FIG. 15 is a diagram illustrating the route DB 130, the adjacency DB 131, the condition DB 133, and NW information DBs 132a and 132b in the second setting example.

The route DB 130 corresponds to the communication route of the traffic addressed to the attack target server 4 illustrated in FIG. 14. The adjacency DB 131 is different from the adjacency DB 131 of the first setting example in that the edge router (#2) 5 and the edge router (#3) 5 are in the adjacency.

In the condition DB 133, the priority condition “link use rate” of the ID “#5” is added, and the priority condition “the number of merging routers” of the ID “#6” is registered instead of the priority condition “router load” of the ID “#2”, as compared with the condition DB 133 of the first setting example.

Furthermore, the loads of the edge routers 5 and the intermediate routers 6 are registered in the NW information DB 132a. Furthermore, the band use rate of each link between the edge router 5 and the intermediate router 6 is registered in the NW information DB 132b. For example, a link ID indicating the link between the edge router (#1) 5 and the edge router (#2) 5 is described as “#1-#2”, and the use rate thereof is 60(%). Furthermore, the link ID indicating the link between the intermediate router (#5) 6 and the intermediate router (#6) 6 is described as “#5-#6”, and the use rate thereof is 40(%).

The NW information DBs 132a and 132b are stored in the HDD 13 instead of the NW information DB 132 of the first setting example. The NW information acquisition unit 103 acquires the load information of the forward processing from the edge routers 5 and the intermediate routers 6 and registers the load information to the NW information DB 132a, and acquires the band information of the links from the edge routers 5 and the intermediate routers 6 and registers the band information to the NW information DB 132b. The NW information DB 132a is used to determine the success or failure of the selection condition “router type” of the ID “#1”, and the NW information DB 132b is used to determine the success or failure of the priority condition “link use rate” of the ID “#5”.

The router selection unit 104 selects a combination of the defense router and the merging router according to the selection conditions and the priority conditions in the condition DB 133.

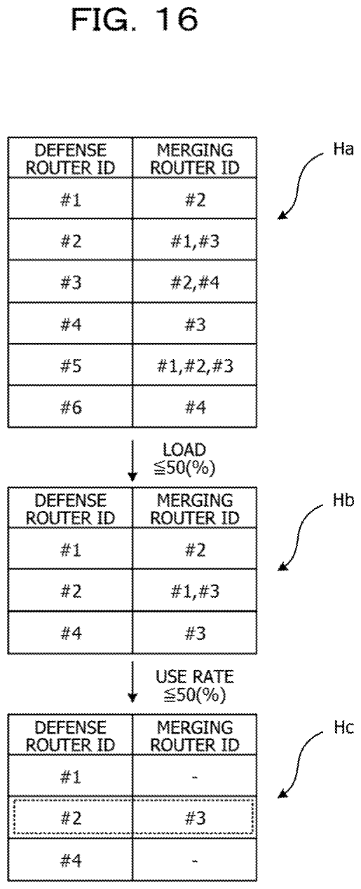

FIG. 16 is a diagram illustrating a method of selecting a combination of the defense router and the merging router in the second setting example. The router selection unit 104 extracts candidates for a combination of the defense router and the merging router that satisfies the selection condition “inter-router hop count” of the ID “#7” on the basis of the adjacency DB 131, as indicated by the reference symbol Ha. The reference symbol Ha indicates a correspondence relationship between the defense routers and the merging routers when the edge routers 5 and the intermediate routers 6 are selected as the defense routers. Note that a merging router ID indicates the router ID of the merging router. The candidates for the merging router are extracted from the edge routers 5.

Next, the router selection unit 104 deletes the other candidates, leaving the candidates for the defense router that satisfies the selection condition “router load” of the ID “#2” as indicated by the reference symbol Hb. Therefore, only the edge routers (#1) 5, (#2) 5, and (#4) 5 having the load of 50(%) or less indicated by the NW information DB 132a remain as the candidates for the defense router.

Next, the router selection unit 104 deletes the other candidates, leaving the candidates for a combination of the defense router and the merging router that satisfies the selection condition “link use rate” of the ID “#5” as indicated by the reference symbol Hc. Therefore, only the combination of the edge routers (#2) 5 and (#3) 5 according to the link ID “#2-#3” having the use rate of 50(%) or less indicated by the NW information DB 132b remains.

Next, the router selection unit 104 selects a combination of the defense router and the merging router having the largest number of merging routers according to the priority condition “the number of merging routers” of the ID “#6” (see the dotted frame). Therefore, the combination of the edge routers (#2) 5 and (#3) 5 having the maximum number (one) of merging routers is selected as the combination of the defense router and the merging router. Note that the other edge routers (#2) 5 and (#3) 5 remain as the candidates for the defense router alone and is finally selected as the defense routers.

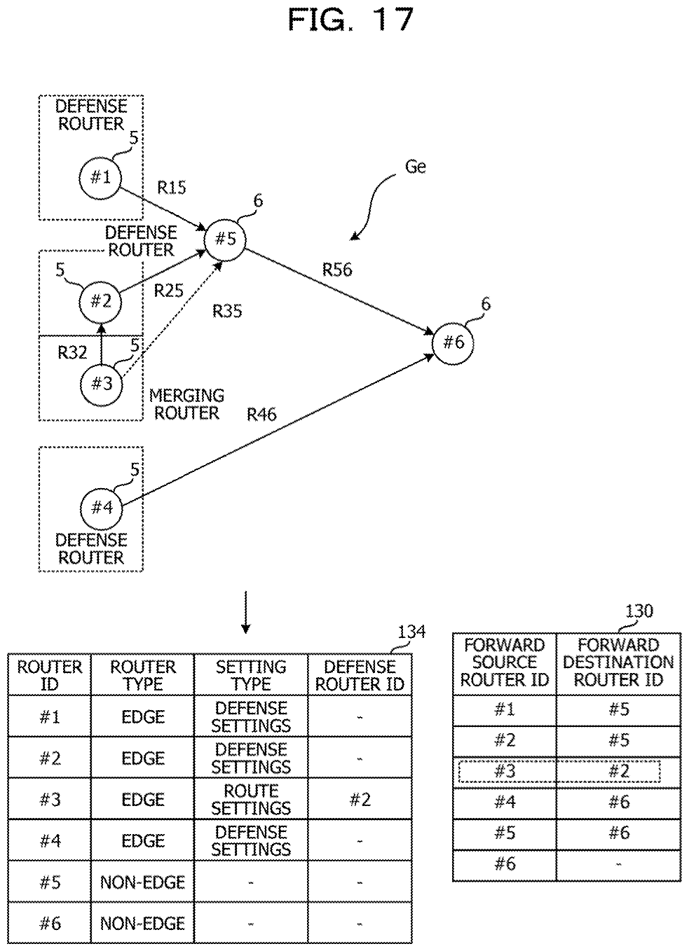

FIG. 17 is a diagram illustrating the route DB 130 and the setting DB 134 at the time of route settings in the second setting example. A graph Ge illustrates the communication routes R25, R32, R15, R56, and R46 of the traffic after the route settings for the edge router (#3) 5. The communication route R35 of the edge router (#3) 5 as the merging router is switched to the communication route R32 toward the edge router (#2) 5 as a corresponding defense router.

The router selection unit 104 determines whether the traffic loops between the defense router and the merging router by checking the communication routes R32 and R25. Since the traffic loop relationship is not established between the defense router and the merging router, the router selection unit 104 updates the route DB 130 and registers the setting DB 134.

The router selection unit 104 updates the route DB 130 according to the switching of the communication route. Thereby, the forward destination router ID of the forward source router ID “#3” is updated from “#5” to “#2”.

Furthermore, the router selection unit 104 registers the defense router and the merging router to the setting DB 134 according to the selection result of the defense router and the merge router. Thereby, the defense settings are registered in the setting types of the router IDs “#1”, “#2”, and “#4”, and the route settings are registered in the setting type of the router ID “#3”. Furthermore, “#2” is registered in the defense router ID of the router ID “#3”.

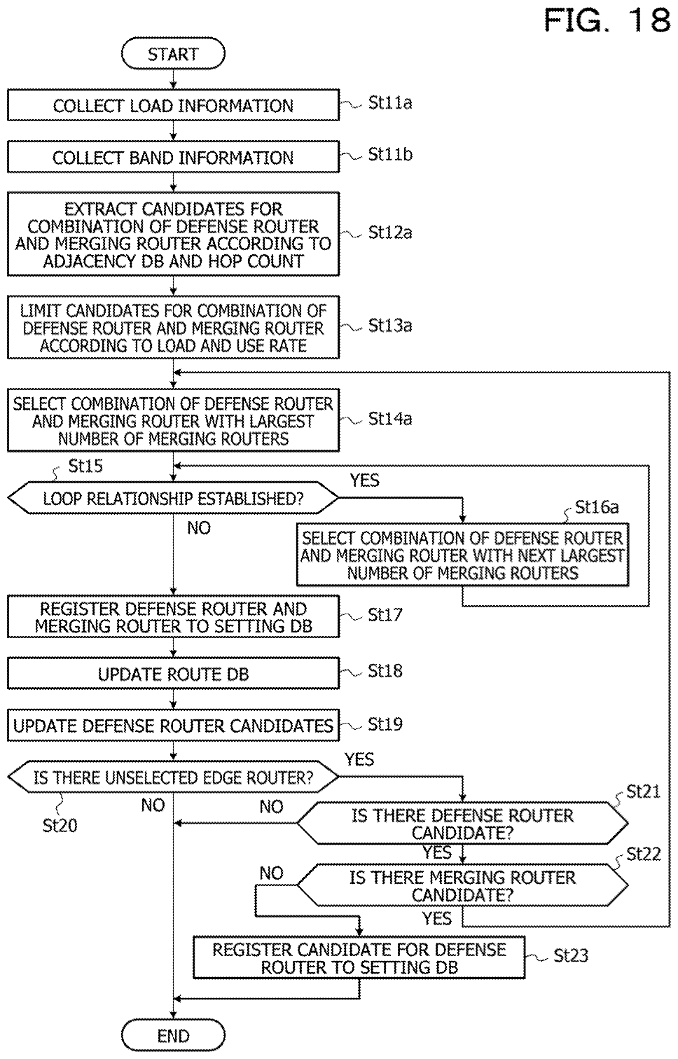

FIG. 18 is a flowchart of selection processing for selecting a defense router and a merging router in the second setting example. In FIG. 18, the processing same as that in FIG. 13 is denoted by the same reference numeral, and description thereof will be omitted.

The NW information acquisition unit 103 acquires the load information from the edge routers 5 and the intermediate routers 6 according to the selection condition “router load” of the ID “#2” registered in the condition DB 133 (step St11a). At this time, the NW information acquisition unit 103 registers the load information to the NW information DB 132a.

Next, the NW information acquisition unit 103 acquires the band information of links from the edge routers 5 and the intermediate routers 6 according to the selection condition “link use rate” of the ID “#5” registered in the condition DB 133 (step St11b). At this time, the NW information acquisition unit 103 calculates the band use rate of each link on the basis of the band information and registers the use rate to the NW information DB 132b.

Next, the router selection unit 104 extracts candidates for a combination of the defense router and the merging router that satisfies the selection condition “inter-router hop count” of the ID “#7” on the basis of the adjacency DB (step St12a). Next, the router selection unit 104 limits the candidates for a combination of the defense router and the merging router to candidates that satisfy the selection condition “router load” of the ID “#2” and the selection condition “link use rate” of the ID “#5” (step St13a).

Next, the router selection unit 104 selects a combination of the defense router and the merging router having the largest number of merging routers according to the priority condition “the number of merging routers” of the ID “#6” (step St14a).

Next, the router selection unit 104 determines whether the traffic loop relationship is established between the defense router and the merging router from the communication route of the traffic addressed to the attack target server 4 (step St5). In the case where the loop relationship is established (Yes in step St15), the router selection unit 104 selects a combination of the defense router and the merging router having the next largest number such as second largest number of merging routers from among the candidates for a combination of the defense router and the merging router (step St16a). Thereafter, the processing of step St15 and the subsequent steps is performed again. Furthermore, in the case where the loop relationship is not established (No in step St15), the processing of step St17 and the subsequent steps is executed.

Furthermore, in the case where there is a candidate for the defense router (Yes in step St21), the router selection unit 104 determines the presence of a candidate for the merging router (step St22). In the case where there is no candidate for the merging router (No in step St22), the router selection unit 104 registers the candidate for the defense router to the setting DB 134 (step St23). Furthermore, in the case where there is a candidate for the merging router (Yes in step St22), the processing of step St14a and the subsequent steps is executed again. In this way, the selection processing is executed.

In this way, the router selection unit 104 selects a combination of the defense router and the merging router in which the band use rate of the link connecting the defense router and the merging router is equal to or less than 50(%), so that the selection condition “link use rate” of the ID “#5” is satisfied. Therefore, since the use rate of the link between the defense router and the merging router is low, compression of other normal traffic due to the attack traffic is reduced.

Furthermore, the router selection unit 104 selects a combination of the defense router and the merging router, giving priority to the number of merging routers, according to the priority condition “the number of merging routers” of the ID “#6”. Therefore, since the number of defense routers in the network 9 is reduced, the load of the forward processing of traffic addressed to the attack target server 4 is reduced.

### Third Setting Example

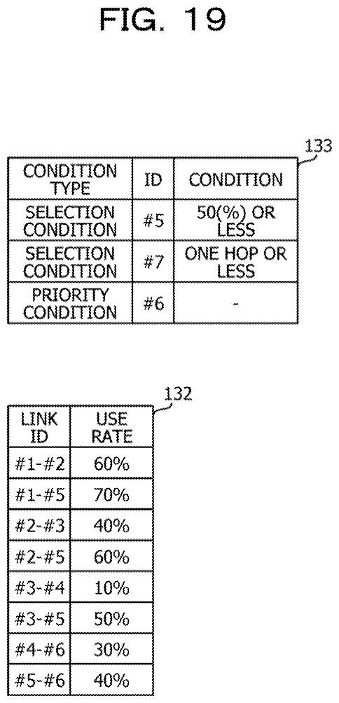

FIG. 19 is a diagram illustrating the condition DB 133 and the NW information DB 132 in a third setting example. The condition DB 133 is obtained by excluding the selection condition “router load” of the ID “#2” from the condition DB 133 of the second setting example. The NW information DB 132 has the use rate whose value is different from that of the NW information DB 132b in the second setting example. Note that the route DB 130 and the adjacency DB 131 are the same as those in the second setting example.

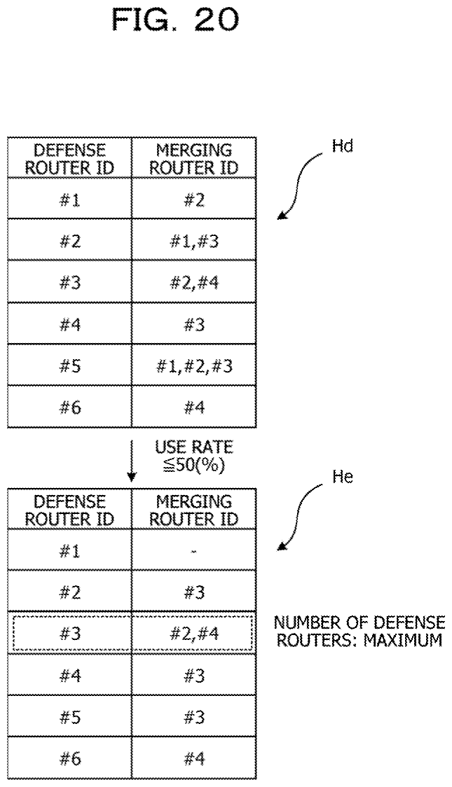

FIG. 20 is a diagram illustrating a method of selecting a combination of the defense router and the merging router in the third setting example. The tables represented by the reference symbols Hd and He are similar to the tables represented by the above reference symbols Ha to Hc.

The router selection unit 104 extracts candidates for a combination of the defense router and the merging router that satisfies the selection condition “inter-router hop count” of the ID “#7” on the basis of the adjacency DB 131, as indicated by the reference symbol Hd.

Next, the router selection unit 104 deletes the other candidates, leaving the candidates for a combination of the defense router and the merging router that satisfies the selection condition “link use rate” of the ID “#5” as indicated by the reference symbol He. Therefore, the combination of the link ID having the use rate larger than 50(%) indicated by the NW information DB 132 is deleted from the table of the reference symbol Hd.

Next, the router selection unit 104 selects a combination of the defense router and the merging router having the largest number of merging routers according to the priority condition “the number of merging routers” of the ID “#6” (see the dotted frame). Therefore, the combination of the edge routers (#3) 5 and (#2) 5 and the combination of the edge routers (#3) 5 and (#4) 5, both combination having the maximum number (two) of merging routers, are selected as the combinations of the defense router and the merging router. Note that the other edge routers (#1) 5 remain as candidates for the defense router alone and will be finally selected as the defense router.

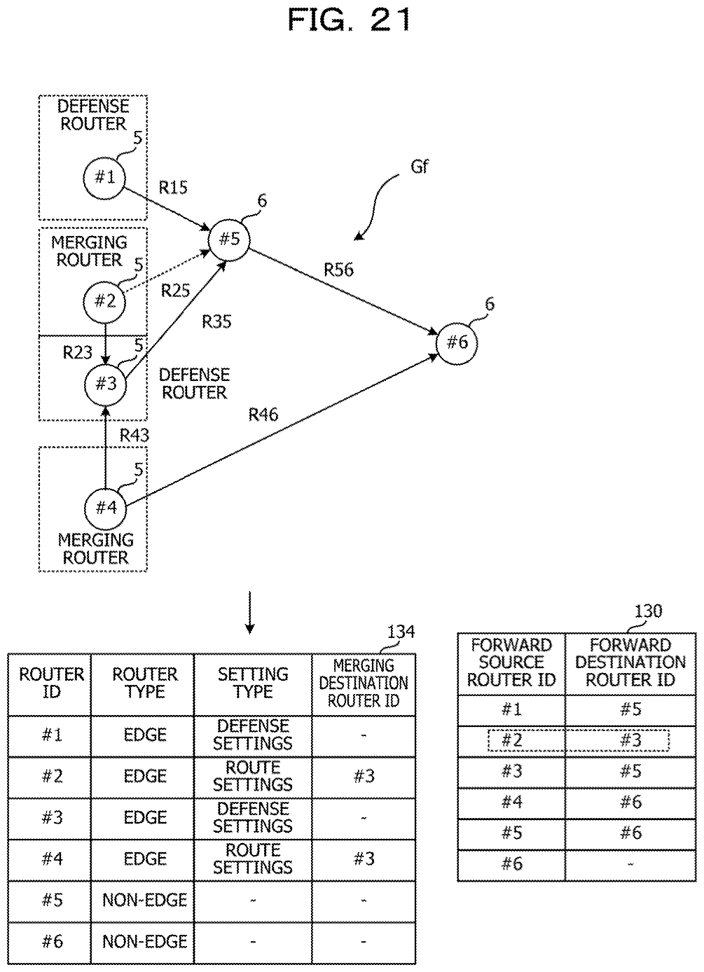

FIG. 21 is a diagram illustrating the route DB 130 and the setting DB 134 at the time of route settings in the third setting example. The router selection unit 104 generates a graph Gf of the network 9. The graph Gf illustrates the communication routes R15, R23, R56, R35, R43, and R46 of the traffic after the route settings for the edge router (#3) 5. The communication route R25 of the edge router (#2) 5 as a merging router is switched to the communication route R23 toward the edge router (#3) 5 as a corresponding defense router.

The router selection unit 104 determines whether the traffic loops between the defense router and the merging router by checking the communication routes R23 and R43. Since the traffic loop relationship is not established between the defense router and the merging router, the router selection unit 104 updates the route DB 130 and registers the setting DB 134.

The router selection unit 104 updates the route DB 130 according to the switching of the communication route. Thereby, the forward destination router ID of the forward source router ID “#2” is updated from “#5” to “#3”.

Furthermore, the router selection unit 104 registers the defense router and the merging router to the setting DB 134 according to the selection result of the defense router and the merge router. Thereby, the defense settings are registered in the setting types of the router IDs “#1” and “#3”, and the route settings are registered in the setting types of the router IDs “#2” and “#4”. Furthermore, “#3” is registered in the defense router IDs of the router IDs “#2” and “#4”.

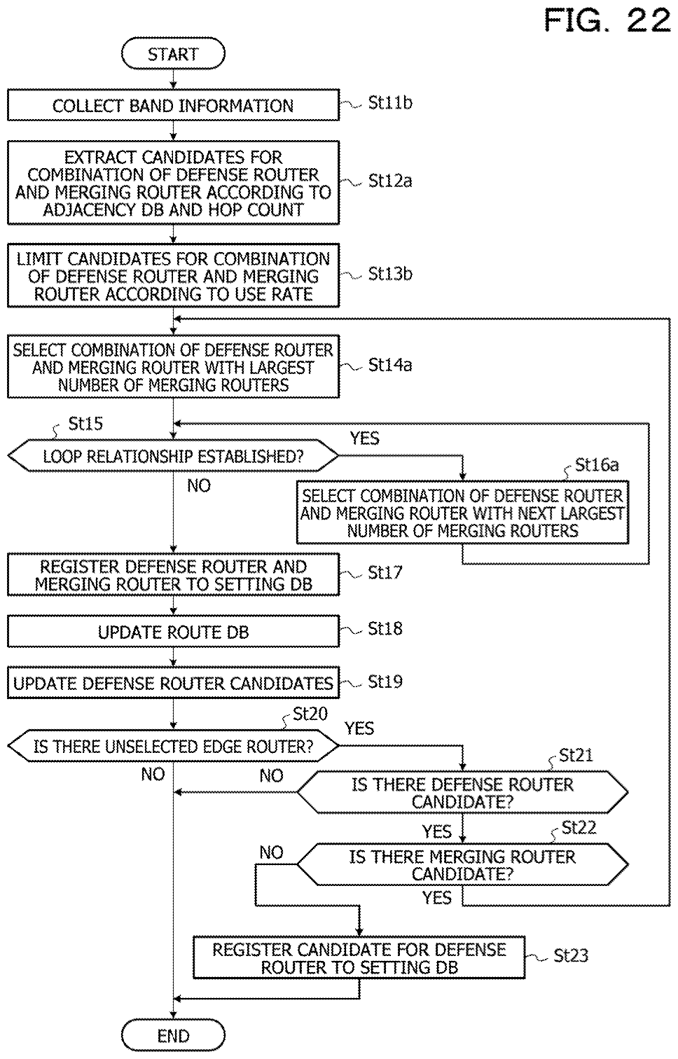

FIG. 22 is a flowchart of selection processing for selecting the defense router and the merging router in the third setting example. In FIG. 22, the processing same as that in FIG. 18 is denoted by the same reference numeral, and description thereof will be omitted.

The NW information acquisition unit 103 acquires the band information of links from the edge routers 5 and the intermediate routers 6 according to the selection condition “link use rate” of the ID “#5” registered in the condition DB 133 (step St11b). At this time, the NW information acquisition unit 103 calculates the band use rate of each link on the basis of the band information and registers the use rate to the NW information DB 132.

Next, the router selection unit 104 extracts candidates for a combination of the defense router and the merging router that satisfies the selection condition “inter-router hop count” of the ID “#7” on the basis of the adjacency DB (step St12a). Next, the router selection unit 104 limits the candidates for a combination of the defense router and the merging router to candidates that satisfy the selection condition “link use rate” of the ID “#5” (step St13b).

Thereafter, the processing of above step St14a and the subsequent steps is executed. In this way, the selection processing is executed. As described above, the router selection unit 104 selects the merging router and the defense router using the selection condition “link use rate” of the ID “#5”, the selection condition “inter-router hop count” of the ID “#7”, and the priority condition “the number of merging routers” of the ID “#6”, whereby effects similar to the effects of the second setting example can be obtained.

(Fourth Setting Example)

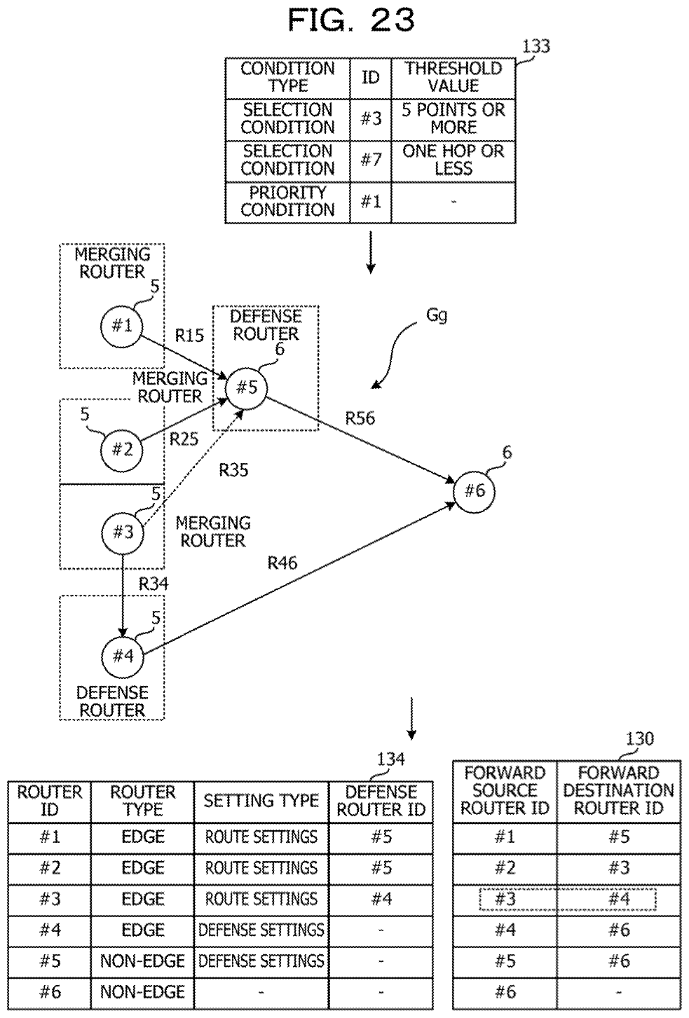

FIG. 23 is a diagram illustrating a setting method in a fourth setting example. It is assumed that the route DB 130 and the adjacency DB 131 in the present example are the same as those in the third setting example.

The selection condition “router performance” of the ID “#3”, the selection condition “inter-router hop count” of the ID “#7”, and the priority condition “router type” of the ID “#1” are registered in the condition DB 133. In the present example, selection conditions and priority conditions of parameters irrelevant to the state of the network 9 that temporally varies are used unlike the first to third setting examples.

As an example, the level of “router performance” is expressed by an index value obtained by converting operating frequencies of the CPUs of the edge router 5 and the intermediate router 6. The index value of the level of the “router performance” is stored in advance in the HDD 13 as the NW information DB 132 as an example.

The selection condition “router performance” of the ID “#3” is based on the edge router 5 and the intermediate router 6 having the index value of 5 points or more. For example, it is assumed that the index value of the edge routers (#1) 5 to (#3) 5 is 3 points, the index value of the edge router (#4) 5 is 5 points, the index value of the intermediate routers (#5) 6 and (#6) 6 is 7 points.

Therefore, the router selection unit 104 extracts the edge router (#4) 5, the intermediate router (#5) 6, and the intermediate router (#6) 6 having the index value of 5 points or more as the candidates for the defense router. Furthermore, the router selection unit 104 selects the candidate for the defense router, giving priority to the edge routers 5 according to the priority condition “router type” of the ID “#1”. Therefore, the router selection unit 104 selects the edge router (#4) 5.

The router selection unit 104 selects a combination of the defense router and the merging router that satisfies the selection condition “inter-router hop count” of the ID “#7” on the basis of the adjacency DB 131. Therefore, the edge routers (#4) 5 and (#3) 5 are selected as the combination of the defense router and the merging router.

Furthermore, the router selection unit 104 selects the intermediate router (#5) 6, the edge router (#1) 5, and the edge router (#2) 5 as a combination of the defense router and the merging router that satisfies the selection condition “inter-router hop count” of the ID “#7” from among the remaining candidates for the defense router.

The router selection unit 104 generates a graph Gg of the network 9. The graph Gg illustrates the communication routes R15, R25, R56, R34, and R46 of the traffic after the route settings for the edge router (#3) 5. The communication route R35 of the edge router (#3) 5 as a merging router is switched to the communication route R34 toward the edge router (#4) 5 as a corresponding defense router.

The router selection unit 104 determines whether the traffic loops between the defense router and the merging router by checking the communication routes R34 and R46. Since the traffic loop relationship is not established between the defense router and the merging router, the router selection unit 104 updates the route DB 130 and registers the setting DB 134.

The router selection unit 104 updates the route DB 130 according to the switching of the communication route. Thereby, the forward destination router ID of the forward source router ID “#3” is updated from “#5” to “#4”.

Furthermore, the router selection unit 104 registers the defense router and the merging router to the setting DB 134 according to the selection result of the defense router and the merge router. Thereby, the defense settings are registered in the setting types of the router IDs “#4” and “#5”, and the route settings are registered in the setting types of the router IDs “#1” to “#3”. Furthermore, “#5”, “#5”, and “#4” are registered in the defense router IDs of the router IDs “#1”, “#2”, and “#3”.

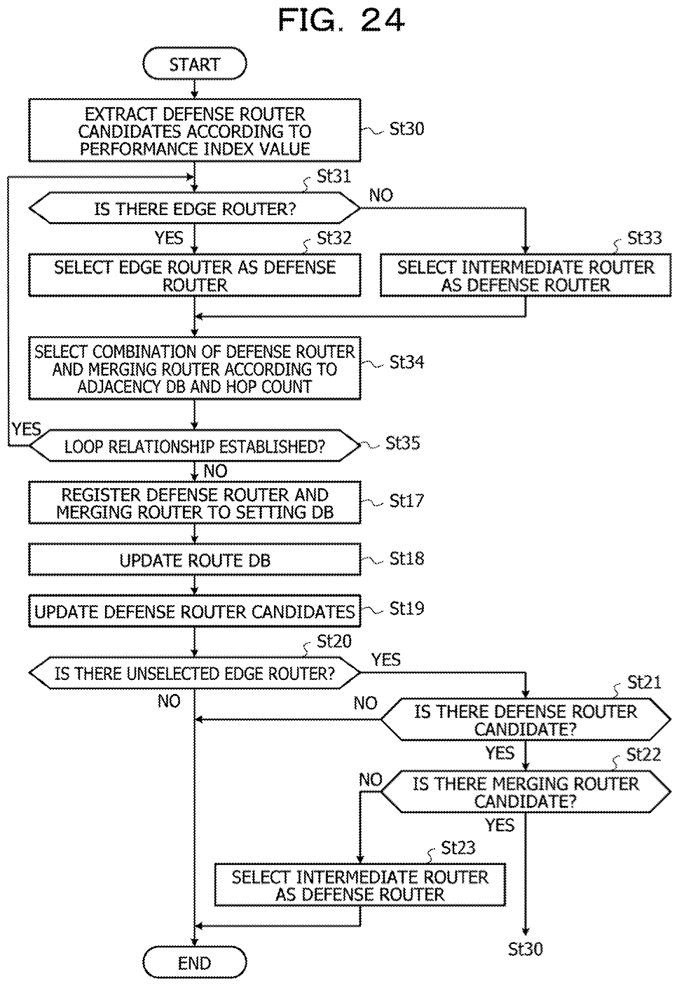

FIG. 24 is a flowchart of selection processing for selecting the defense router and the merging router in the fourth setting example. In FIG. 24, the processing same as that in FIG. 18 is denoted by the same reference numeral, and description thereof will be omitted.

The router selection unit 104 extracts the edge routers 5 and the intermediate routers 6 having the index value of 5 points or more according to the selection condition “router performance” of the ID “#3” as the candidates for the defense router (step St30). Next, the router selection unit 104 determines whether there is the edge router 5 in the candidates for the defense router according to the priority condition “router type” of the ID “#1” (step St31).

In the case where there is the edge router 5 (Yes in step St31), the router selection unit 104 selects the edge router 5 as the defense router (step St32). Furthermore, in the case where there is no edge router 5 (No in step St31), the router selection unit 104 selects the intermediate router 6 as the defense router (step St33). Next, the router selection unit 104 selects a combination of the defense router and the merging router that satisfies the selection condition “inter-router hop count” of the ID “#7” on the basis of the adjacency DB 131 according to the selected defense router (step St34).

Next, the router selection unit 104 determines whether the traffic loop relationship is established between the defense router and the merging router from the communication route of traffic addressed to the attack target server 4 (step St35). In the case where the loop relationship is established (Yes in step St35), the router selection unit 104 executes the processing of step St31 and the subsequent steps again. Furthermore, in the case where the loop relationship is not established (No in step St35), the processing of step St17 and the subsequent steps is executed. Furthermore, in the case where there is a candidate for the merging router (Yes in step St22), the processing of step St30 and the subsequent steps is executed again. In this way, the selection processing is executed.

In this way, the router selection unit 104 selects the defense router, giving priority to the level of the performance of the traffic forward processing. Therefore, the defense router has a capability of promptly detecting and discarding the attack traffic. Therefore, an influence on the forward processing of other normal traffic is reduced.

As described above, the router selection unit 104 selects the defense router and the merging router so as to satisfy the selection condition regarding the load of the forward processing of traffic in the network and not to allow the traffic to loop from among the edge routers 5 and the intermediate routers 6 on the basis of the communication routes and the connection relationship between the edge routers 5 and the intermediate routers 6. The route setting processing unit 106 sets a communication route of traffic for the merging router such that communication routes merge at the defense router. The defense setting processing unit 105 instructs the defense router to suppress forwarding of attack traffic.

According to the above configuration, a device that suppresses the attack traffic can be limited to the defense router, and occurrence of a loop of the traffic can be suppressed. Furthermore, the defense router and the merging router satisfy the selection condition regarding the load of the forward processing of the traffic in the network 9. Therefore, an increase in the load of the forward processing of normal traffic other than the attack traffic can be suppressed.

Therefore, the NW management server 1 can suppress an increase in the load of the forward processing of other traffic due to suppression of forwarding of the attack traffic.

The embodiments described above are preferred examples. However, the present embodiment is not limited to this, and a variety of modifications can be made without departing from the scope of the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network management device for managing a network including a plurality of edge routers and a plurality of intermediate routers connected between the plurality of edge routers, the network management device comprising:
a memory; and
a processor coupled to the memory and configured to:
calculate respective communication routes of traffic to be forwarded from each of the plurality of edge routers to an attack target device that receives an attack from an outside of the network,
set a communication route of traffic to a second router such that the communication routes merge at a first router, and
instruct the first router to suppress forwarding of traffic of the attack, wherein, the processor selects the first router and the second router so as to satisfy a condition regarding a load of forward processing of traffic in the network and not to allow the traffic to loop from among the plurality of edge routers and the plurality of intermediate routers on the basis of a connection relationship between the plurality of edge routers and the plurality of intermediate routers.

2. The network management device according to claim 1,
wherein the condition is that the load of forward processing of traffic of the first router is equal to or less than a threshold value.

3. The network management device according to claim 1,
wherein the condition is that a distance between the first router and the second router is equal to or less than a threshold value.

4. The network management device according to claim 1,
wherein the condition is that a band use rate of a link between the first router and the second router is equal to or less than a threshold value.

5. The network management device according to claim 1,
wherein the condition is that an increase amount of a distance from the second router to the attack target device is equal to or less than a threshold value by the setting of the communication route to the second router.

6. The network management device according to claim 1,
wherein the condition is that the first router is one of the plurality of edge routers.

7. The network management device according to claim 1,
wherein the condition is that a setting amount for suppressing traffic by the first router is equal to or less than a threshold value.

8. The network management device according to claim 1,
wherein the processor is configured to select the first router and the second router by giving priority to the number of the second routers.

9. The network management device according to claim 1,
wherein the processor is configured to select the first router by giving priority to a level of performance of the forward processing of traffic.

10. The network management device according to claim 1,
wherein the processor is configured to select the first router and the second router based on the communication routes and a connection relationship between the plurality of edge routers and the plurality of intermediate routers.

11. A method for managing a network including a plurality of edge routers and a plurality of intermediate routers connected between the plurality of edge routers, the method comprising:
calculating respective communication routes of traffic to be forwarded from each of the plurality of edge routers to an attack target device that receives an attack from an outside of the network;
setting the communication route of traffic to a second router such that the communication routes merge at a first router;
instructing the first router to suppress forwarding of traffic of the attack; and
selecting the first router and the second router so as to satisfy a condition regarding a load of forward processing of traffic in the network and not to allow the traffic to loop from among the plurality of edge routers and the plurality of intermediate routers on the basis of a connection relationship between the plurality of edge routers and the plurality of intermediate routers.

12. A network system, comprising:
a plurality of edge routers;
a plurality of intermediate routers; and
a management device configured to:
calculate respective communication routes of traffic to be forwarded from each of the plurality of edge routers to an attack target device that receives an attack from an outside of the network,
set a communication route of traffic to a second router such that the communication routes merge at a first router, and
instruct the first router to suppress forwarding of traffic of the attack, wherein, the processor selects the first router and the second router so as to satisfy a condition regarding a load of forward processing of traffic in the network and not to allow the traffic to loop from among the plurality of edge routers and the plurality of intermediate routers on the basis of a connection relationship between the plurality of edge routers and the plurality of intermediate routers.
